(19) United States
(12) Patent Application Publication
(10) Pub. No.: US 2024/0110043 A1
(43) Pub. Date: Apr. 4, 2024

(54) STABILIZER COMPOSITION FOR SILYL-MODIFIED POLYMER SEALANTS

(71) Applicants: Clariant International Ltd., Muttenz (CH); Omya International AG, Oftringen (CH)

(72) Inventors: Jean-Yves DESRATS, Mulhouse (FR); Antonio DI RISIO, Koenigstein im Taunus (DE); Mouhcine KANOUNI, Tampa, FL (US); Andrea BATTISTI, Zuerich (CH); David Pietro GRASSINI, Albizzate (VA) (IT)

(21) Appl. No.: 18/261,065

(22) PCT Filed: Jan. 11, 2022
(86) PCT No.: PCT/EP2022/050390

§ 371 Date: Jul. 11, 2023

(30) Foreign Application Priority Data
Jan. 12, 2021 (EP) 21151071.4

(51) Int. Cl. C08K 5/3492; C08K 5/134; C08K 5/20; C08K 5/353; C08L 71/02

(52) U.S. Cl. CPC C08K 5/3492; C08K 5/1345; C08K 5/20; C08K 5/353; C08L 71/02; C08L 2201/08

(57) ABSTRACT

The invention is directed to stabilizer compositions comprising at least one oxalanilide UV absorber and/or at least one (2-hydroxyphenyl)-s-triazine UV absorber, and at least one oligomeric hindered amine light stabilizer (HALS), optionally further comprising at least one phenolic antioxidant, at least one liquid diluent and/or further components. Said stabilizer compositions are preferably used in sealants or adhesives based on silyl-modified polymers (SMP). The invention also deals with a polymer composition based on silyl-modified polymers (SMP) comprising the new stabilizer combination of oxalanilide UV absorber and/or (2-hydroxyphenyl)-s-triazine UV absorber, and oligomeric hindered amine light stabilizer (HALS), optionally further comprising phenolic antioxidant and liquid diluent and/or further components.

The present invention is directed to stabilizer compositions comprising at least one oxalanilide UV absorber and/or at least one (2-hydroxyphenyl)-s-triazine UV absorber, and at least one oligomeric hindered amine light stabilizer (HALS), optionally further comprising at least one phenolic antioxidant, at least one liquid diluent and/or further components. Said stabilizer compositions are preferably used in sealants or adhesives based on silyl-modified polymers (SMP). The invention also deals with a polymer composition based on silyl-modified polymers (SMP) comprising the new stabilizer combination of oxalanilide UV absorber and/or (2-hydroxyphenyl)-s-triazine UV absorber, and oligomeric hindered amine light stabilizer (HALS), optionally further comprising phenolic antioxidant and liquid diluent and/or further components.

Furthermore, the invention is directed to a process for preparing the stabilizer compositions and the use of these stabilizer compositions as heat and/or UV stabilizer in SMP sealants and adhesives.

Silyl-modified polymers (SMP), such as silyl-modified polyethers (also known as MS polymers), silyl-modified polyurethanes (also known as SPUR polymers), and silyl-modified acrylic polymers, as well as their use as sealants and adhesives for example in the building and construction industry, are known for many years, see e.g. US 2002/198308, U.S. Pat. No. 6,077,896, EP-A 1 288 247, and US 2003/0105261. Examples of commercial SMP products are Kaneka MS Polymers (such as MS Polymer® S203H, MS Polymer® S303H) or Polymers ST from Evonik. A broad range of MS Polymer® grades are commercially available, which differ in degree of functionalization (number and nature of groups attached to the backbone) and backbone structure in a wide viscosity range.

Such silyl-modified polymers can be the basis of moisture-curable 1K or 2K sealant or adhesive compositions, wherein such compositions can be stored in a substantially moisture-free state and, when exposed to atmospheric conditions, rapidly undergoes curing from the surface. Typically, SMP sealant cures from a liquid or gel state to an elastic solid, wherein curing entails cross-linking of the polymer chains by the hydrolysis and cross-linking reaction of the silyl groups.

Silyl-modified polymers (SMPs) are e.g. used in the building and construction industry, aerospace, automotive, marine and other allied industries applications as both sealants and adhesives for many years. These products are typically (iso)cyanate and solvent free and exhibit good characteristics, such as adhesion on a wide range of substrate materials, excellent durability of adhesion with limited surface treatment and good temperature and UV stability. Typically, the key features of SMP sealants are that they are extremely flexible and paintable.

WO 2016/081823 describes stabilizer compositions for protecting organic materials from UV light and thermal degradation. The stabilizer compositions comprise an UV absorber selected from orthohydroxyphenyl triazine compounds, orthohydroxybenzophenone compounds, orthohydroxyphenyl benzotriaziole compounds, and benzoxazinone compounds, a co-active agent (e.g. selected from C₁₂-C₆₀ alcohols, fatty acid esters and alkoxylated derivatives thereof) and a hindered amine light stabilizer (HALS).

The document US 2010/0087576 describes moisture-curable organosilicon compositions comprising an oxalanilide UV stabilizer. Furthermore, the combination of UV absorbers and hindered amine light stabilizers in silyl-modified polymer sealants is for example described in JP 2010/248408 and CN 107892900.

The document CN 106833479 discloses silane polyether sealants for automotive applications, comprising a heat stabilizer, an UV absorber, a hindered amine light stabilizer and an antioxidant.

The document JP 2010/270241 describes silicone foams that contain a stabilizer comprising a hindered phenol antioxidant, a hindered amine light stabilizer and an UV absorber.

WO 2012/010570 teaches an additive combination for sealants (e.g. sealants based on silane terminated polyethers), wherein the additive combination comprises at least two different sterically hindered amines, for example Tinuvin® 622 and Tinuvin® 144, and an UV absorber, for example Tinuvin® 312. The document discloses an additive combination comprising at least two sterically hindered amines, at least one further stabilizer, a dispersing agent (dispersant polymer) and a plasticizer. However, HALS stabilizers such as Tinuvin® 622 exhibit low solubility in sealant compositions and are therefore unfavourable.

Currently, a combination of a hindered amine light stabilizer and a benzotriazole type UV absorber is frequently used in the SMP sealant industry for light and heat stabilization. Often a combination of HALS bis(2,2,6,6-tetramethyl-4-piperidinyl) sebacat (CAS-No. 52829-07-9) and UV absorber 2-(2′-Hydroxy-3′-tert-butyl-5′-methylphenyl)-5-chlorobenzotriazole (CAS-No. 3896-11-5) is used to provide light and heat stabilization. However, benzotriazole type UV absorbers have the disadvantage of yellowing of SMP sealants and adhesives before and during the application resulting in a coloration of the final product which is not acceptable in many applications.

Additionally, the stabilizer Tinuvin® 5866, which is a blend of an oxalanilide UV absorber and a basic HALS stabilizer, is frequently used in SMP compositions. As a disadvantage, these stabilizers are classified as hazardous according to current EU regulations for Classification, Labeling and Packaging of Chemical Substances. Moreover, these stabilizers are typically solid and provided as powder. Application of pulverulent stabilizers has the disadvantage of being more difficult in dosing, in particular small amounts, and pulverulent stabilizers are prone to dusting during measuring, mixing and/or application. Furthermore, the formation of agglomerates of pulverulent stabilizers impedes the homogeneous distribution of the stabilizer in the final product of the costumer and typically requires expensive processing (e.g. milling) of pulverulent stabilizer compositions.

There is a need to provide novel and improved stabilizer combinations for SMP sealants, which have improved heat and weathering resistance, do not cause initial yellowing, which means yellowing after mixing with the polymer (e.g. in a cartridge) before the curing step, are free of hazardous compounds, do not cause impairment of the color of the stabilized SMP compositions after thermal treatment, and finally do not impair the performance of the SMP sealants, e.g. mechanical properties, chemical resistance, adhesion, and rheological properties. Moreover, stabilizer combinations with improved applicability in terms of dosing and applications are desired. In view of this, there is a need for stabilizer compositions, which have a good solubility in common SMP sealants. In this respect, a need for liquid stabilizer compositions for many applications can be identified.

It has been surprisingly found, that a stabilizer combination, in particular a synergistic stabilizer combination, of at least one oxalanilide UV absorber and/or at least one (2-hydroxyphenyl)-s-triazine UV absorber, and at least one selected hindered amine light stabilizer (HALS), optionally comprising at least one selected phenolic antioxidant, and at least one liquid diluent provides a significant improvement in the area of light and heat stabilization, without affecting the inherent advantageous properties of cured SMP sealants, such as elongation, tensile strength and paintability. The liquid diluent further improves the applicability of the stabilizer combination by an easy and quick provision and even distribution of the stabilizer combination in the final SMP sealants.

### DESCRIPTION OF THE INVENTION

The present invention is directed to a stabilizer composition comprising:

(A) at least one UV absorber as component A, wherein the UV absorber A comprises:
(A1) one or more (2-hydroxyphenyl)-s-triazine compounds according to formula (I.1) as component A1:

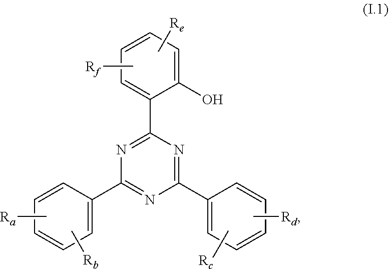

wherein
Rₐ, Rₐ, R_{c}, R_{d}, Rₑ and R_{f} are independently of one another selected from hydrogen, alkyl groups having from 1 to 20 carbon atoms, alkoxy groups having from 1 to 20 carbon atoms and 1 to 4 oxygen atoms;
and/or
(A2) one or more oxalanilide compounds according to formula (I.2) as component A2:

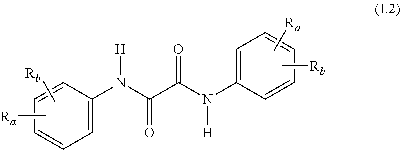

wherein
Rₐ and R_{b} are independently of one another selected from hydrogen, alkyl groups having from 1 to 20, preferably 2 to 12, carbon atoms, alkoxy groups having from 1 to 20, preferably 2 to 12, carbon atoms and 1 to 4, preferably 1 to 2, oxygen atoms (oxygen atoms of alkoxy group(s));
   and

(B) at least one hindered amine light stabilizer as component B, comprising at least one oligomeric hindered amine light stabilizer B1 according to formula (II)-1:

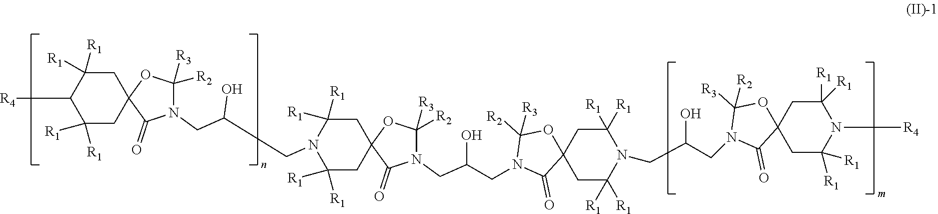

n and m are independently of one another a number from 0 to 100, preferably 0 to 10, more preferably 0 to 5, with the proviso that n and m are not both 0;
R₁ is hydrogen, a cycloalkyl group having from 5 to 7 carbon atoms, or an alkyl group having from 1 to 12 carbon atoms;
R₂ and R₃ are independently of one another selected from hydrogen, an alkyl group having from 1 to 18 carbon atoms, or are, together with the carbon atom connecting them, a 5- to 13-membered cycloalkyl ring, or are, together with the carbon atom connecting them, a group of formula (II)-4

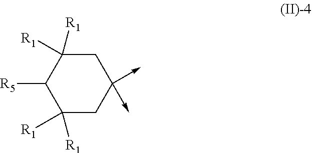

in which is R₁ as defined above; and
R₄ and R₅ are independently of one another selected from hydrogen, an alkyl group having from 1 to 22 carbon atoms, an oxygen radical O*, —OH, —NO, —CH₂CN, benzyl, allyl, an alkyloxy group having from 1 to 30 carbon atoms, a cycloalkyloxy group having from 5 to 12 carbon atoms, a aryloxy group having from 6 to 10 carbon atoms in which additionally the aryl radical may be substituted, a arylalkyloxy group having from 7 to 20 carbon atoms in which additionally the aryl radical may be substituted, an alkenyl group having from 3 to 10 carbon atoms, an alkynyl group having from 3 to 6 carbon atoms, an acyl group having from 1 to 10 carbon atoms, halogen, unsubstituted phenyl or C₁-C₄-alkyl-substituted phenyl.

The stabilizer composition may optionally comprise further components, in particular at least one of the following components C, D and/or E:

(C) at least one phenolic antioxidant as component C;

(D) at least one liquid diluent as component D, and

(E) at least one further additive as component E.

The inventive stabilizer composition can advantageously be used in sealants and adhesives on the basis of silyl-modified polymers, such as silyl-modified polyethers. The stabilizer compositions result in an improved UV and heat stability and prevent initial yellowing of SMP sealants compared with standard stabilization (for example Tinuvin® 326). Further, the inventive stabilizer compositions do not cause impairment of the color (e.g. based on CIE color system) after thermal treatment of the stabilized SMP compositions. Preferably, the mechanical properties of the stabilized SMP compositions are equal or improved.

Preferably, the inventive stabilizer composition requires no classification as hazardous according to current EU regulations for Classification, Labeling and Packaging of Chemical Substances (CLP). In particular the regulations apply as described in Regulation (EC) No 1272/2008 of the European Parliament and of the Council of 16 Dec. 2008 on classification, labelling and packaging of substances and mixtures, amending and repealing Directives 67/548/EEC and 1999/45/EC, and amending Regulation (EC) No 1907/2006.

The inventive stabilizer composition is preferably in form of a substantially liquid composition, such as a solution, dispersion, emulsion, suspension, or paste, preferably a solution or suspension, in particular a solution. In particular, the stabilizer composition is in a substantially liquid form due to the liquid diluent D. Moreover, one or more of the components A, B, C and/or E may be in liquid form.

For the purposes of the present invention, the term “substantially liquid” means that the composition, as well as the predominant liquid fraction, may further comprise a certain fraction of solid constituents, examples being undissolved constituents A, B and optionally C and/or E.

For the purposes of the present invention, the term “liquid” means that the composition is at least of low fluidity at room temperature, preferably at least in the range from 10° C. to 30° C., more preferably at least in the range from 0° C. to 40° C.

For the purposes of the present invention, the term “alkyl” includes linear straight-chain or branched alkyl. Preference is given to straight-chain C1-C20 alkyl, in particular straight-chain C1-C18 alkyl, preferably straight-chain C1-C12-alkyl and branched C3-C20 alkyl, in particular branched C3-C18 alkyl, preferably branched C3-C12 alkyl. Examples of alkyl groups are, in particular, methyl, ethyl, n-propyl, isopropyl, n-butyl, isobutyl, sec-butyl, tert-butyl, n-pentyl, isopentyl, 1-methylbutyl, tert-pentyl, neopentyl, n-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, n-heptyl, n-octyl, 1-methylheptyl, 2-ethylhexyl, 2,4,4-trimethyl-pentyl, 1,1,3,3-tetramethylbutyl, n-nonyl, n-decyl, n-undecyl, n-dodecyl, n-tridecyl, n-tetradecyl, n-pentadecyl, n-hexadecyl, n-heptadecyl, n-octadecyl and n-eicosyl.

For the purpose of the present invention, the term “alkoxy” is an alkyl group bound via an oxygen atom, wherein the carbon chain of the alkyl group can be interrupted by one or more, preferably 1 to 3, nonadjacent heteroatoms —O—. Preference is given to alkyl groups described above. Examples of alkoxy groups are, methoxy, ethoxy, n-propoxy, 1-methylethoxy, butoxy, 1-methylpropoxy, 2-methylpropoxy, 1,1-dimethylethoxy, n-pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy or 1-ethyl-2-methylpropoxy, hexoxy, a group —(OC₂H₄)ᵤ—(OC₃H₆)ᵥ—H with u and v are independently from each other a number from 0 to 19, preferably 0 to 12, with the proviso that u+v are from 1 to 20, preferably 2 to 12.

### Stabilizer Compositions

The stabilizer compositions of the present invention at least comprise (or consist of):

(A) at least one UV absorber as component A, wherein the UV absorber A comprises (or consist of):
(A1) one or more (2-hydroxyphenyl)-s-triazine compounds according to formula (I.1) as component A1:

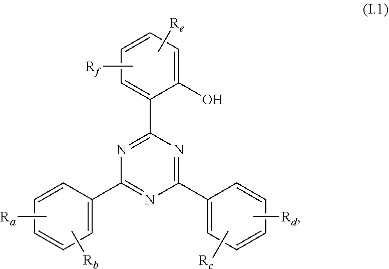

wherein
Rₐ, R_{b}, R_{c}, R_{d}, Rₑ and R_{f} are independently of one another selected from hydrogen, alkyl groups having from 1 to 20 carbon atoms, alkoxy groups having from 1 to 20 carbon atoms and 1 to 4 oxygen atoms;
and/or
(A2) one or more oxalanilide compounds according to formula (I.2) as component A2:

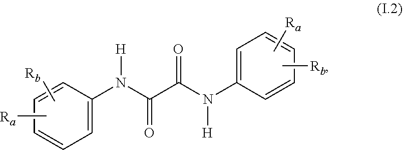

wherein
Rₐ and R_{b} are independently of one another selected from hydrogen, alkyl groups having from 1 to 20 carbon atoms, alkoxy groups having from 1 to 20 carbon atoms and 1 to 4 oxygen atoms, and/or

and

(B) at least one hindered amine light stabilizer as component B, comprising (or consisting of) at least one oligomeric hindered amine light stabilizer B1 according to formula (II)-1:

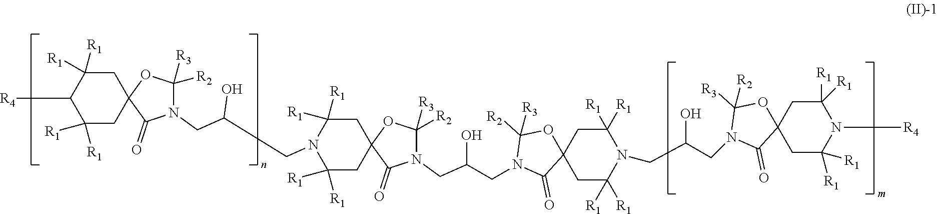

n and m are independently of one another a number from 0 to 100, preferably 0 to 10, more preferably 0 to 5, with the proviso that n and m are not both 0;
R₁ is hydrogen, a cycloalkyl group having from 5 to 7 carbon atoms, or an alkyl group having from 1 to 12 carbon atoms;
R₂ and R₃ are independently of one another selected from hydrogen, an alkyl group having from 1 to 18 carbon atoms, or are, together with the carbon atom connecting them, a 5- to 13-membered cycloalkyl ring, or are, together with the carbon atom connecting them, a group of formula (II)-4

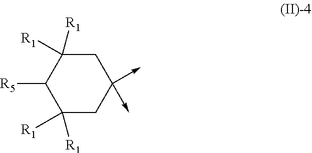

in which is R₁ as defined above; and
R₄ and R₅ are independently of one another selected from hydrogen, an alkyl group having from 1 to 22 carbon atoms, an oxygen radical O*, —OH, —NO, —CH₂CN, benzyl, allyl, an alkyloxy group having from 1 to 30 carbon atoms, a cycloalkyloxy group having from 5 to 12 carbon atoms, a aryloxy group having from 6 to 10 carbon atoms in which additionally the aryl radical may be substituted, a arylalkyloxy group having from 7 to 20 carbon atoms in which additionally the aryl radical may be substituted, an alkenyl group having from 3 to 10 carbon atoms, an alkynyl group having from 3 to 6 carbon atoms, an acyl group having from 1 to 10 carbon atoms, halogen, unsubstituted phenyl or C₁-C₄-alkyl-substituted phenyl.

Besides the UV absorber A and the hindered amine light stabilizer B, the stabilizer composition may further comprise one or more of the following components C, D, and/or E:
(C) at least one phenolic antioxidant as component C;
(D) at least one liquid diluent as component D; and/or
(E) at least one further additive as component E.

In one embodiment of the invention, the stabilizer compositions of the present invention at least comprise (or consist of):
(A) at least one UV absorber as component A, wherein the UV absorber A comprises (or consists of) one or more (2-hydroxyphenyl)-s-triazine compounds according to formula (I.1) as component A1;
and
(B) at least one hindered amine light stabilizer as component B, comprising (or consisting of) the at least one oligomeric hindered amine light stabilizer B1.

In an alternative embodiment of the invent, the stabilizer compositions of the present invention at least comprise (or consist of):
(A) at least one UV absorber as component A, wherein the UV absorber A comprises (or consists of) one or more oxalanilide compounds according to formula (I.2) as component A2
and
(B) at least one hindered amine light stabilizer as component B, comprising (or consisting of) the at least one oligomeric hindered amine light stabilizer B1.

In a further alternative embodiment of the invention, the stabilizer compositions of the present invention at least comprise (or consist of):
(A) at least one UV absorber as component A, wherein the UV absorber A comprises (or consists of):
   (A1) one or more (2-hydroxyphenyl)-s-triazine compounds according to formula (I.1) as component A1;
   and
   (A2) one or more oxalanilide compounds according to formula (I.2) as component A2;
and
(B) at least one hindered amine light stabilizer as component B, comprising (or consisting of) the at least one oligomeric hindered amine light stabilizer B1.

In a preferred embodiment of the invention, the stabilizer composition is in liquid form. This may be achieved by using UV absorbers A and/or hindered amine light stabilizers B which are liquid at room temperature, preferably at least in the range from 10° C. to 30° C., more preferably at least in the range from 0° C. to 40° C.

In an alternative embodiment, the stabilizer composition further comprises at least one liquid diluent D to provide the stabilizers composition in liquid form. The liquid diluent D can be selected from suitable liquid diluents, such as suitable solvents or liquid adjuvants or combinations of the afore mentioned. Thus, in one embodiment of the invention, the stabilizer composition comprises (or consists of):
(A) the at least one UV absorber A;
(B) the at least one hindered amine light stabilizer B; and
(D) at least one liquid diluent as component D.

In one embodiment of the invention, the stabilizer composition comprises (or consists of):
(A) the at least one UV absorber A;
(B) the at least one hindered amine light stabilizer B; and
(C) at least one phenolic antioxidant as component C.

It has been found that the addition of at least one phenolic antioxidant as component C further improves the heat stability and UV stability of SMP compositions comprising the stabilizer combination of components A, B, and C.

In a further preferred embodiment of the invention, the stabilizer composition comprises (or consists of):
(A) the at least one UV absorber A;
(B) the at least one hindered amine light stabilizer B; and
(C) at least one phenolic antioxidant as component C, wherein the antioxidant C is composed of one or more phenolic compounds according to the formulae (III)a and/or (III)b:

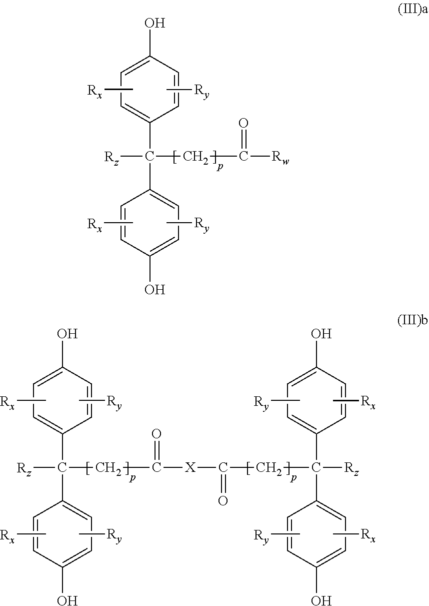

wherein
Rₓ and R_{y} are independently of one another selected from hydrogen, halogen or an alkyl group having from 1 to 10 carbon atoms;
R_{z} is selected from hydrogen or an alkyl group having from 1 to 10 carbon atoms;
R_{w} is selected from a hydroxy group, an alkoxy group having from 1 to 18 carbon atoms, a phenyl alkoxy group having from 1 to 4 alkyl carbon atoms, a cycloalkoxy group having from 5 to 8 carbon atoms, or a group of formula (III)c

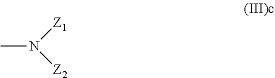

in which Z₁ and Z₂ are independently of one another selected from hydrogen, an alkyl group having from 1 to 18, a phenyl group and a cycloalkyl group having from 5 to 8 carbon atoms;
X is selected from —O—(CH₂)_{q}—O—; —(OCH₂—CH₂)_{q}—O—; —O—(CH₂)_{q}—S—(CH₂)_{q}—O; —NH—(CH₂)_{q}—NH—; —NH—NH—, with q is an integer from 1 to 12, or a group

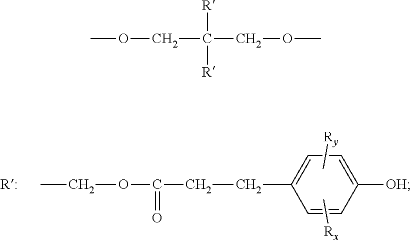

and
p is zero or an integer from 1 to 6, preferably from 1 to 4.

In a further embodiment of the invention, the stabilizer composition is provided in a substantially liquid form wherein at least one of the components A, B, and/or optionally C is provided in liquid form.

In an alternative embodiment, the stabilizer composition further comprises at least one liquid diluent D to provide the stabilizers composition in liquid form, the stabilizer composition comprising (or consisting of):
(A) the at least one UV absorber as component A;
(B) the at least one hindered amine light stabilizer as component B;
(C) the at least one phenolic antioxidant as component C; and
(D) at least one liquid diluent as component D.

In a further embodiment of the invention, the stabilizer composition may further comprise at least on further additive as component E. The invention thus also relates to a stabilizer composition, comprising:
(A) the at least one UV absorber as component A;
(B) the at least one hindered amine light stabilizer as component B; and
(E) at least one further additive as component E.

In one embodiment of the invention, the stabilizer composition comprises (or consists of):
(A) the at least one UV absorber as component A;
(B) the at least one hindered amine light stabilizer as component B;
(C) the at least one phenolic antioxidant as component C; and
(E) at least one further additive as component E.

In a further embodiment of the invention, the stabilizer composition is provided in a substantially liquid form comprising (or consisting of):
(A) the at least one UV absorber as component A;
(B) the at least one hindered amine light stabilizer as component B;
(C) the at least one phenolic antioxidant as component C; and
(E) at least one further additive as component E;
wherein at least one of the components A, B, C, and/or E is provided in liquid form.

In a further, alternative embodiment of the invention, the stabilizer composition is provided in a substantially liquid form comprising (or consisting of):
(A) the at least one UV absorber as component A;
(B) the at least one hindered amine light stabilizer as component B;
(C) at least one phenolic antioxidant as component C;
(D) at least one liquid diluent as component D; and
(E) at least one further additive as component E;
wherein at least component D and optionally at least one of the components A, B, C, and/or E is provided in liquid form.

In one embodiment of the invention, the stabilizer composition comprises (or consists of):
(A) the at least one UV absorber as component A;
(B) the at least one hindered amine light stabilizer as component B;
(C) optionally at least one phenolic antioxidant as component C;
(D) optionally at least one liquid diluent as component D; and
(E) optionally at least one further additive as component E.

In a preferred embodiment, the stabilizer composition comprises (or consists of):
(A) 20 to 60% by weight, preferably 25 to 50% by weight, more preferably 30 to 45% by weight, based on the total stabilizer composition, of the at least one UV absorber A; and
(B) 40 to 80% by weight, preferably 50 to 75% by weight, more preferably 55 to 70% by weight, based on the total stabilizer composition, of the at least one hindered amine light stabilizer B;
wherein the amounts of components A and B sum up to 100% by weight of the stabilizer composition.

In an alternative, preferred embodiment, the stabilizer composition comprises (or consists of):
(A) 15 to 49% by weight, preferably 20 to 44% by weight, more preferably 25 to 39% by weight, based on the total stabilizer composition, of the at least one UV absorber A;
(B) 20 to 69% by weight, preferably 30 to 64% by weight, more preferably 40 to 59% by weight, based on the total stabilizer composition, of the at least one hindered amine light stabilizer B; and
(C) 1 to 50% by weight, preferably 1 to 30% by weight, more preferably 1 to 20% by weight, based on the total stabilizer composition, of the at least one phenolic antioxidant C;
wherein the amounts of components A, B and C sum up to 100% by weight of the stabilizer composition.

In an alternative, preferred embodiment, the stabilizer composition comprises (or consists of):
(A) 5 to 49% by weight, preferably 8 to 39% by weight, more preferably 10 to 29% by weight, based on the total stabilizer composition, of the at least one UV absorber A;
(B) 10 to 59% by weight, preferably 12 to 49% by weight, more preferably 15 to 39% by weight, based on the total stabilizer composition, of the at least one hindered amine light stabilizer B;
(C) 1 to 50% by weight, preferably 1 to 20% by weight, more preferably 1 to 15% by weight, based on the total stabilizer composition, of the at least one phenolic antioxidant C;
(D) 30 to 79% by weight, preferably 35 to 69% by weight, more preferably 40 to 64% by weight, based on the total stabilizer composition, of the at least one liquid diluent D; and
(E) 0 to 50% by weight, preferably 0 to 20% by weight, more preferably 0 to 10% by weight, based on the total stabilizer composition, of at least one further additive E;
wherein the amounts of components A, B, C, D, and E sum up to 100% by weight of the stabilizer composition.

In case that the optional component E is present the amount of the component A may be adapted in that the sum of the amounts is or does not exceed 100% by weight.

Preferably, the UV absorber A and the hindered amine light stabilizer B are present in the inventive stabilizer composition in a weight ratio of A:B in the range of 10:1 to 1:10, preferably 5:1 to 1:5, more preferably 2:1 to 1:2, in particular 1:1 to 1:2.

Preferably, the UV absorber A and the antioxidant C — if antioxidant C is present—are present in the inventive stabilizer composition in a weight ratio of A:C in the range of 10:1 to 1:5, preferably 8:1 to 1:1, more preferably 5:1 to 1.5:1.

In a preferred embodiment, the inventive stabilizer composition comprises (or preferably consists of):
(A) 8 to 39% by weight, preferably 10 to 29% by weight, more preferably 10 to 20% by weight, based on the total stabilizer composition, of the at least one UV absorber A;
(B) 12 to 49% by weight, preferably 15 to 39% by weight, more preferably 20 to 35% by weight, based on the total stabilizer composition, of the at least one hindered amine light stabilizer B;
(C) 1 to 20% by weight, preferably 1 to 15% by weight, more preferably 2 to 10% by weight, based on the total stabilizer composition, of the at least one phenolic antioxidant C; and
(D) 35 to 69% by weight, preferably 40 to 64% by weight, more preferably 40 to 55% by weight, based on the total stabilizer composition, of the at least one liquid diluent D;
wherein the amounts of components A, B, C, and D sum up to 100% by weight of the stabilizer composition.

In another preferred embodiment, the inventive stabilizer composition comprises (or preferably consists of):
(A) 10 to 29% by weight, more preferably 12 to 25% by weight, more preferably 13 to 20% by weight, based on the total stabilizer composition, of the at least one UV absorber A;
(B) 15 to 39% by weight, more preferably 20 to 35% by weight, more preferably 22 to 33% by weight, based on the total stabilizer composition, of the at least one hindered amine light stabilizer B;
(C) 1 to 15% by weight, preferably 2 to 10% by weight, more preferably 3 to 9% by weight, based on the total stabilizer composition, of the at least one phenolic antioxidant C;
(D) 40 to 64% by weight, preferably 40 to 55% by weight, more preferably 43 to 53% by weight, based on the total stabilizer composition, of the at least one liquid diluent D, preferably comprising at least one liquid moisture scavenger and/or at least one solvent;
wherein the amounts of components A, B, C, D, and E sum up to 100% by weight of the stabilizer composition.

In another preferred embodiment, the inventive stabilizer composition comprises (or preferably consists of):
(A) 10 to 29% by weight, based on the total stabilizer composition, of the at least one UV absorber A;
(B) 15 to 39% by weight, based on the total stabilizer composition, of the at least one hindered amine light stabilizer B;
(C) 1 to 15% by weight, based on the total stabilizer composition, of the at least one phenolic antioxidant C;
(D) 40 to 64% by weight, based on the total stabilizer composition, of the at least one liquid diluent D;
(E) 0.01 to 20% by weight, based on the total stabilizer composition, of at least one at least one further additive E,
wherein the amounts of components A, B, C, D, and E sum up to 100% by weight of the stabilizer composition.

### UV Absorber (Component A)

The inventive stabilizer composition comprises an UV absorber as component A, wherein the UV absorber is selected from one or more oxalanilide compounds which is oxalanilide (N,N′ diphenyloxalic acid diamide, CAS-No. 620-81-5) or derivatives thereof, and/or one or more (2-hydroxyphenyl)-s-triazine compounds. Preferably, the UV absorber component A does not comprise a hydroxy substituted oxalanilide compound.

It was surprisingly found that, in contrast to conventional stabilizer compositions, in particular stabilizer compositions comprising benzotriazole type UV absorbers, the combination of the UV absorber A with an oligomeric hindered amine light stabilizer B1 results in an improvement of the stabilizer combination, in particular in view of color.

Preferably, the UV absorber A is present in an amount of 20 to 60% by weight, preferably 25 to 50% by weight, more preferably 30 to 45, based on the total amount of components A and B in the stabilizer composition. In a preferred embodiment, the UV absorber A is present in an amount of 5 to 49% by weight, preferably 8 to 39% by weight, more preferably 10 to 29% by weight, also preferably 12 to 25% by weight, in particular 13 to 20% by weight, based on the total amount of components A, B, C, D, and E in the stabilizer composition.

### Component A1

In one embodiment, the UV absorber A comprises or is composed of one or more (2-hydroxyphenyl)-s-triazine compounds A1 according to formula (I.1):

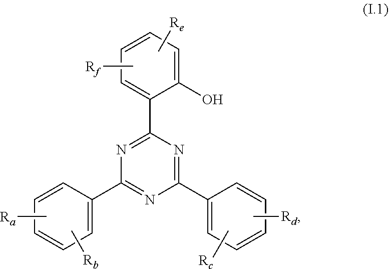

wherein
Rₐ, R_{b}, R_{c}, R_{d}, Rₑ and R_{f} are independently of one another selected from hydrogen, alkyl groups having from 1 to 20 carbon atoms, alkoxy groups having from 1 to 20 carbon atoms and 1 to 4 oxygen atoms.

The substituents Rₐ, R_{b}, R_{c}, and/or R_{d} are preferably in the meta-positions on each ring. Preferably, at least one substituent Rₐ, R_{b}, R_{c}, and/or R_{d} on each ring is not hydrogen. More preferably, Preferably, Rₐ, R_{b}, R_{c}, and R_{d} are in the meta-positions on each ring and are not hydrogen, i.e. Rₐ, R_{b}, R_{c}, and R_{d} are selected from alkyl groups having from 1 to 20 carbon atoms, alkoxy groups having from 1 to 20 carbon atoms and 1 to 4 oxygen atoms.

In a preferred embodiment, substituents Rₐ, R_{b}, R_{c}, and R_{d} represent alkyl groups having from 1 to 20, preferably 1 to 12, more preferably 1 to 4 carbon atoms. More preferably, substituent Rₐ, R_{b}, R_{c}, and R_{d} are selected from methyl, ethyl or propyl, more preferably methyl, and are present in the meta-positions on each ring.

The substituents Rₑ and/or R_{f} are preferably in the ortho and/or para-position. Preferably, one substituent Rₑ or R_{f} on the ring is hydrogen. Preferably, one substituent Rₑ or R_{f} on the ring is hydrogen and the substituent Rₑ or R_{f} which is not hydrogen is in para-position on the ring.

In a preferred embodiment one substituent Rₑ or R_{f} on the ring is hydrogen, and one substituent Rₑ or R_{f} on the ring is in para-position and represents an alkoxy group having from 1 to 20, preferably 5 to 18, more preferably 10 to 17, carbon atoms and 1 to 4, preferably 2 to 4, oxygen atoms. More preferably one substituent Rₑ or R_{f} on the ring is hydrogen, and one substituent Rₑ or R_{f} in para-position on the other ring is a C₁₀-C₁₇ alkoxy group, more preferably a substituent of the following formula (I.1)-a:

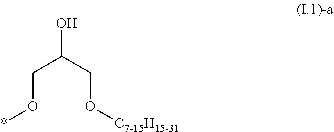

In a further preferred embodiment, the UV absorber A comprises or consist of one or more (2-hydroxyphenyl)-s-triazine compounds A1 according to formula (I.1′):

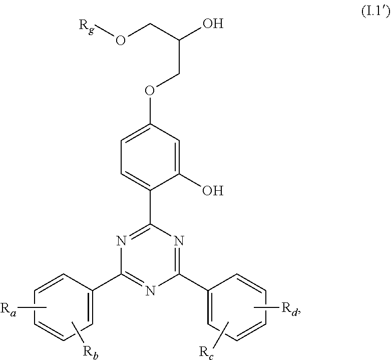

wherein
Rₐ, R_{b} R_{c}, and R_{d} are defined as above, and
R_{g} is selected from an alkyl group having from 7 to 15 carbon atoms.

A preferred UV absorber A comprises or consists of one or more (2-hydroxyphenyl)-s-triazine compounds A1 selected from compounds of the following formulae (I.1)-1 and (I.1)-2:

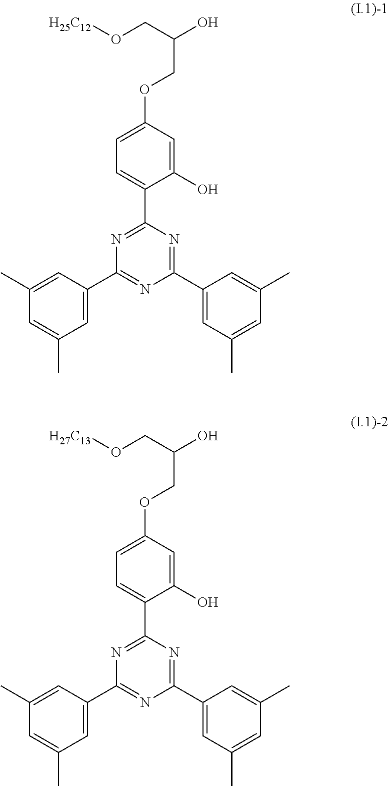

In a preferred embodiment of the invention, the preferred UV absorber A comprises or consists of a mixture of (2-hydroxyphenyl)-s-triazine compounds A1 selected from compounds of the above formulae (I.1)-1 and (I.1)-2. Preferably, UV absorber A comprises a mixture of (2-hydroxyphenyl)-s-triazine compounds selected from compounds (I.1)-1 and (I.1)-2 in a ratio of compound (I.1)-1 to compound (I.1)-2 of about 1:5 to 5:1, more preferably 1:2 to 2:1, in particular 1:1.2 to 1.2:1.

### Component A2

In an alternative embodiment, stabilizer composition comprises a UV absorber A which comprises or consists of one or more oxalanilide compounds A2 according to formula (I.2):

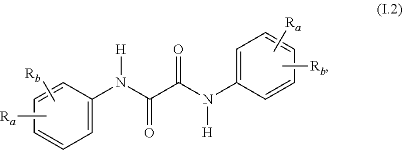

wherein
Rₐ and R_{b} are independently of one another selected from hydrogen, alkyl groups having from 1 to 20, preferably 2 to 12, carbon atoms, alkoxy groups having from 1 to 20, preferably 2 to 12, carbon atoms and 1 to 4, preferably 1 to 2, oxygen atoms (i.e. alkoxy oxygen atoms).

The substituents Rₐ and/or R_{b} are preferably in the ortho and/or para-position. Preferably, one substituent Rₐ or R_{b} on each ring is hydrogen. Preferably, one substituent Rₐ or R_{b} on each ring is hydrogen and the substituents Rₐ or R_{b} which are not hydrogen are in ortho-position on each ring.

In a preferred embodiment one substituent Rₐ or R_{b} on one ring is an alkyl group having from 1 to 20, preferably 2 to 12, more preferably 2 to 4 carbon atoms, and one substituent Rₐ or R_{b} on the other ring is an alkoxy group having from 1 to 20, preferably 2 to 12, carbon atoms and 1 to 4, preferably 1 to 2, oxygen atoms. More preferably one substituent Rₐ or R_{b} on one ring is methyl, ethyl or propyl, more preferably ethyl, and one substituent Rₐ or R_{b} on the other ring is a C₂-C₄ alkoxy group, more preferably —OCH₂CH₃.

A preferred UV absorber A comprises or consists of one or more oxalanilide compounds A2 selected from compounds of the following formulae (I.2)-1 to (I.2)-7:

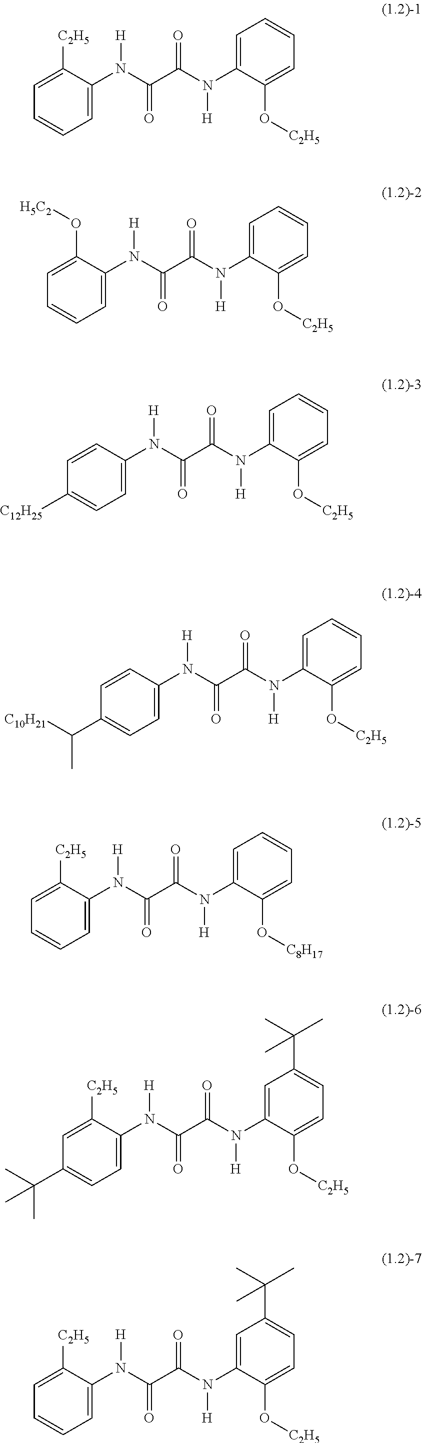

In a preferred embodiment, the UV absorber A is composed of one of the oxalanilide compounds mentioned above.

Preferably, the UV absorber A comprises (or consists of) the oxalanilide compound A2 according to formula (I.2)-1 (N-(2-ethoxyphenyl)-N′-(2-ethylphenyl)-ethylene diamide; 2-Ethyl-2′-ethoxy-oxalanilide, CAS-No. 23949-66-8) as mentioned above.

Preferred oxalanilide compounds suitable as constituents of UV absorber component A are described in U.S. Pat. Nos. 5,969,014 and/or 6,916,867.

In one further preferred embodiment, the UV absorber A is composed of one or more (2-hydroxyphenyl)-s-triazine compounds A1 according to formula (I.2) as defined above, one or more oxalanilide compounds A2 according to formula (I.1) as defined above, or a mixture comprising one or more (2-hydroxyphenyl)-s-triazine compounds A1 according to formula (I.1) as defined above and one or more oxalanilide compounds A2 according to formula (I.2) as defined above. Preferably, the ratio of compounds of formula (I.1) to compounds of formula (I.2) in a mixture thereof may range from about 1:5 to 5:1, more preferably 1:2 to 2:1.

In a further preferred embodiment, the UV absorber A comprises one or more (2-hydroxyphenyl)-s-triazine compounds A1 according to formula (I.1) as defined above, optionally in a mixture comprising one or more oxalanilide compounds A2 according to formula (I.2) as defined above. Preferably, the UV absorber A comprises at least 30% by weight, more preferably at least 40% by weight, in particular at least 50% by weight, based on the total UV absorber A, of one or more (2-hydroxyphenyl)-s-triazine compounds A1 according to formula (I.1) as defined above, and optionally up to 70% by weight, more preferably up to 60% by weight, in particular up to 50% by weight, based on the total UV absorber A, of one or more oxalanilide compounds A2 according to formula (I.2) as defined above. It has been found that a synergistic effect is obtained with respect to UV stability (crack resistance) of silyl-modified polymers (SMP) for silyl-modified polymers comprising stabilizer compositions comprising a combination of (2-hydroxyphenyl)-s-triazine UV absorbers A1 as defined above, optionally oxalanilide UV absorbers A2 as defined above as UV absorber A, and oligomeric hindered amine light stabilizers (HALS) B1, optionally phenolic antioxidants C and optionally liquid diluents D, wherein the (2-hydroxyphenyl)-s-triazine UV absorber A1 accounts for at least 50% weight of the total amount of UV absorber A.

Preferably, the UV absorber A is used in a substantially liquid form. The UV absorber A may be liquid itself or may be used in combination with a liquid diluent D, preferably at least one inert, organic solvent. Suitable solvents are selected from inert polar or inert apolar organic solvents, which are commonly used in the art. The at least one inert, organic solvent accounts to the liquid diluent D according to the invention. For the purpose of this invention, inert solvent are solvents which are chemically inert towards any of the components A, B, C, D, and/or E at room temperature, preferably at least in the range from 10° C. to 30° C., more preferably at least in the range from 0° C. to 40° C., i.e. solvents which do not chemically react with any of the components A, B, C, D, and/or E at room temperature, preferably at least in the range from 10° C. to 30° C., more preferably at least in the range from 0° C. to 40° C.

In one embodiment, the UV absorber A is applied in combination with at least one inert solvent, in particular at least one inert, polar organic solvent. Suitable polar solvents comprise ethers, glycol ethers, and in particular methoxypropanol. The at least one inert, polar organic solvent accounts to the liquid diluent D according to the invention.

In an alternative embodiment, the UV absorber A is applied in combination with at least one inert, apolar organic solvents, preferably aliphatic or aromatic hydrocarbons, such as petroleum ether, hexane, heptane, petroleum fractions, toluene, cyclohexane, mesitylene or xylene, for example. The at least one inert, apolar organic solvent accounts to the liquid diluent D according to the invention.

Suitable UV absorbers A are commercially available from Clariant as Hostavin® 3206 LIQ and Hostavin® 3400 LIQ.

### Hindered Amine Light Stabilizer (Component B)

It was surprisingly found that the combination of the UV absorber A with an oligomeric hindered amine light stabilizer B1 results in stabilizer combinations, with unique property profile in particular in view of heat stability, UV/weathering resistance and color.

Thus, the inventive stabilizer composition comprises at least hindered amine light stabilizer (HALS) as component B, comprising at least one oligomeric hindered amine light stabilizer B1 according to formula (II)-1 as defined herein above.

Preferably, the hindered amine light stabilizer is composed of one or more compounds including a tetramethylpiperdinyl group according to formula (II):

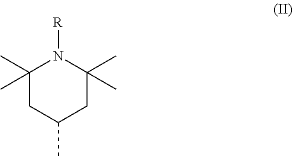

with R is selected from hydrogen, alkyl groups having from 1 to 20, preferably 2 to 12, carbon atoms, alkoxy groups having from 1 to 20, preferably 2 to 12, carbon atoms and 1 to 4, preferably 1 to 2, oxygen atoms (i.e. alkoxy oxygen atoms).

Preferably, the hindered amine light stabilizer (HALS), used as component B, does not require a classification as hazardous according to current EU regulations for Classification, Labelling and Packaging of Chemical Substances (CLP).

Preferably, the hindered amine light stabilizer B is present in an amount of 40 to 80% by weight, preferably 50 to 75% by weight, more preferably 55 to 70% by weight, based on the total amount of components A and B in the stabilizer composition. In a preferred embodiment, the hindered amine light stabilizer B is present in an amount of 10 to 59% by weight, preferably 12 to 49% by weight, more preferably 15 to 39% by weight, also preferably 20 to 35% by weight, in particular 22 to 33% by weight, based on the total amount of components A, B, C, D, and E in the stabilizer composition.

Preferably, the hindered amine light stabilizer (HALS) component B, comprises up to 100% by weight of the at least one oligomeric hindered amine light stabilizer B1, more preferably up to 95% by weight. Besides the oligomeric hindered amine light stabilizer B1, component B may comprise further hindered amine light stabilizers. Examples of suitable hindered amine light stabilizer are 2-dodecyl-N-(2,2,6,6-tetramethyl-4-piperidinyl)succinimide (CAS-No 79720-19-7); bis(2,2,6,6-tetramethyl-4-piperidinyl)sebacat (CAS-No 52829-07-9); bis(1,2,2,6,6-pentamethyl-4-piperidinyl)sebacat (CAS-No 41556-26-7); bis(1-octyloxy-2,2,6,6-tetramethyl-4-piperidinyl)sebacat (CAS-No 129757-67-1); 2,2,4,4-tetramethyl-7-oxa-3,20-diazadispiro-20-(2,3-epoxi-propyl) dispiro-(5.1.11.2)-heneicosane-21-one (CAS-No. 64338-16-5) and mixtures thereof.

Examples of suitable oligomeric hindered amine light stabilizer B1 include reaction products of 2,2,4,4-tetramethyl-7-oxa-3,20-diazadispiro-20-(2,3-epoxi-propyl)dispiro-(5.1.11.2)-heneicosane-21-one and epichlorohydrin (Hostavin® N30 from Clariant).

The hindered amine light stabilizer B comprises at least one oligomeric hindered amine light stabilizer B1 according to formula (II)-1 as defined herein above. For the purpose of the present invention, the oligomeric hindered amine light stabilizer B1 is made up from at least 2 repeating units, preferably ≥3 repeating units. Preferably, the oligomeric hindered amine light stabilizer B1 is made up from ≤300 repeating units, more preferably ≤202 repeating units, even more preferably ≤22 repeating units and in particular ≤12 repeating units.

More preferably the hindered amine light stabilizer B is composed of a mixture of oxadiaza-spirodecane compounds according to formulae (II)-1 and (II)-2 and optionally (II)-3 as defined below.

In a preferred embodiment, the hindered amine light stabilizer B is composed of 65 to 95% by weight, preferably 75 to 94% by weight, more preferably 85 to 95% by weight, based on component B, of at least one compound of formula (II)-1, 5 to 35% by weight, preferably 5 to 20% by weight, more preferably 5 to 12% by weight, based on component B, of at least one compound of formula (II)-2, and 0 to 10% by weight, preferably 1 to 5% by weight, more preferably 1 to 3% by weight, based on component B, of at least one compound of formula (II)-3:

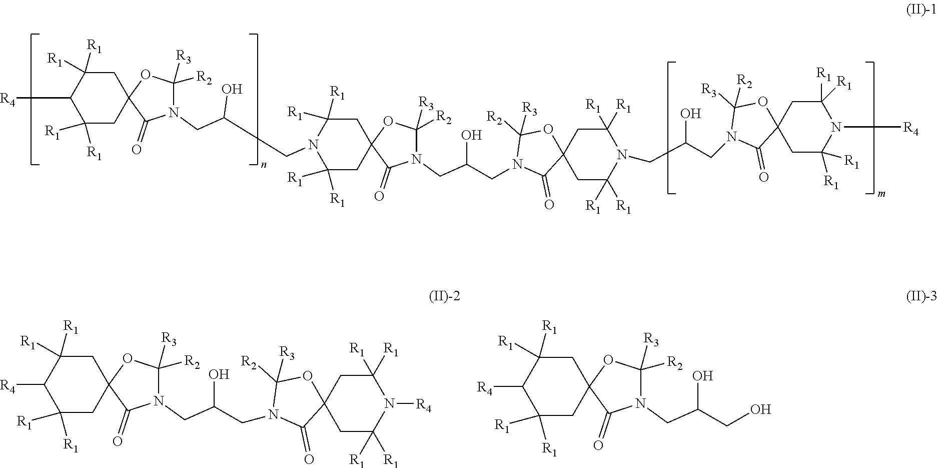

n and m are independently of one another a number from 0 to 100, preferably 0 to 10, more preferably 0 to 5, with the proviso that n and m are not both 0;
R₁ is hydrogen, a cycloalkyl group having from 5 to 7 carbon atoms, or an alkyl group having from 1 to 12 carbon atoms;
R₂ and R₃ are independently of one another selected from hydrogen, an alkyl group having from 1 to 18 carbon atoms, or are, together with the carbon atom connecting them, a 5- to 13-membered cycloalkyl ring, or are, together with the carbon atom connecting them, a group of formula (II)-4

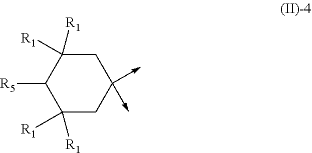

in which is R₁ as defined above; and
R₄ and R₅ are independently of one another selected from hydrogen, an alkyl group having from 1 to 22 carbon atoms, an oxygen radical O*, —OH, —NO, —CH₂CN, benzyl, allyl, an alkyloxy group having from 1 to 30 carbon atoms, a cycloalkyloxy group having from 5 to 12 carbon atoms, a aryloxy group having from 6 to 10 carbon atoms in which additionally the aryl radical may be substituted, a arylalkyloxy group having from 7 to 20 carbon atoms in which additionally the aryl radical may be substituted, an alkenyl group having from 3 to 10 carbon atoms, an alkynyl group having from 3 to 6 carbon atoms, an acyl group having from 1 to 10 carbon atoms, halogen, unsubstituted phenyl or C₁-C₄-alkyl-substituted phenyl.

Preferably, the inventive stabilizer composition comprises a hindered amine light stabilizer B composed of 65 to 95% by weight, preferably 75 to 94% by weight, more preferably 85 to 95% by weight, based on component B, of at least one compound of formula (II)-1, 5 to 35% by weight, preferably 5 to 20 by weight, more preferably 5 to 12% by weight, based on component B, of at least one compound of formula (II)-2, and 0 to 10% by weight, preferably 1 to 5% by weight, more preferably 1 to 3% by weight, based on component B, of at least one compound of formula (II)-3 as shown above;
wherein
n and m are independently of one another a number from 0 to 100, preferably 0 to 10, more preferably 0 to 5, with the proviso that n and m are not both 0;
R₁ is hydrogen, a cycloalkyl group having from 5 to 7, preferably 6, carbon atoms, or an alkyl group having from 1 to 12, preferably 1 to 6, carbon atoms;
R₂ and R₃ are independently of one another selected from hydrogen, an alkyl group having from 1 to 18 carbon atoms, or are, together with the carbon atom connecting them, a 5- to 13-membered cycloalkyl ring, or are, together with the carbon atom connecting them, a group of formula (II)-4 as defined above; and
R₄ and R₅ are independently of one another selected from hydrogen, an alkyl group having from 1 to 22 carbon atoms, an oxygen radical O*, —OH, —NO, —CH₂CN, benzyl, allyl, an alkyloxy group having from 1 to 30 carbon atoms, a cycloalkyloxy group having from 5 to 12 carbon atoms, a aryloxy group having from 6 to 10 carbon atoms in which additionally the aryl radical may be substituted, a arylalkyloxy group having from 7 to 20 carbon atoms in which additionally the aryl radical may be substituted, an alkenyl group having from 3 to 10 carbon atoms, an alkynyl group having from 3 to 6 carbon atoms, an acyl group having from 1 to 10 carbon atoms, halogen, unsubstituted phenyl or C₁-C₄-alkyl-substituted phenyl.

Preferred embodiments of the stabilizer component B, which is a mixture of the compounds according to formula (II)-1, (II)-2, and optionally (II)-3, are for example described in U.S. Pat. No. 6,174,940 and/or US 2005/0228086. The substituents R₁ to R₅ of formulae (II)-1 to (II)-4 and indices n and m refer to the corresponding substituents and indices defined in U.S. Pat. No. 6,174,940.

Preferably, the HALS component B is composed of the compounds according to formulae (II)-1 and (II)-2 and optionally (II)-3, wherein the substituents R₁ to R₅ have the same definitions.

Preferably, the HALS component B is composed of the compounds according to formulae (II)-1 and (II)-2 and optionally (II)-3, wherein
n and m are independently of one another a number from 0 to 10, more preferably 0 to 5, with the proviso that n and m are not both 0;
R₁ is hydrogen, a cycloalkyl group having 6 carbon atoms, or an alkyl group having from 1 to 4 carbon atoms;
R₂ and R₃ are independently of one another selected from hydrogen, an alkyl group having from 1 to 6 carbon atoms, or are, together with the carbon atom connecting them, a 6- to 12-membered cycloalkyl ring, or are, together with the carbon atom connecting them, a group of formula (II)-4; and
R₄ and R₅ are independently of one another selected from hydrogen, an alkyl group having from 1 to 5 carbon atoms, an oxygen radical O*, —OH, —NO, —CH₂CN, benzyl, allyl, an alkyloxy group having from 1 to 10 carbon atoms, a cycloalkyloxy group having from 5 to 6 carbon atoms, a aryloxy group having from 6 to 7 carbon atoms in which additionally the aryl radical may be substituted, a arylalkyloxy group having from 7 to 10 carbon atoms in which additionally the aryl radical may be substituted, an alkenyl group having from 3 to 6 carbon atoms, an alkynyl group having from 3 to 6 carbon atoms, an acyl group having from 1 to 4 carbon atoms, halogen, unsubstituted phenyl or C₁-C₂-alkyl-substituted phenyl.

More preferably, the HALS component B is composed of compounds according to formulae (II)-1 and (II)-2 and optionally (II)-3, wherein
n and m are independently of one another a number from 0 to 5, with the proviso that n and m are not both 0;
R₁ is an alkyl group having from 1 to 4 carbon atoms, more preferably methyl;
R₂ and R₃ are, together with the carbon atom connecting, them a 6- to 12-membered cycloalkyl ring, preferably a 12 membered cycloalkyl ring, or are, together with the carbon atom connecting them, a group of formula (II)-4;
R₄ and R₅ are independently of one another selected from hydrogen, an alkyl group having from 1 to 4 carbon atoms, an alkyloxy group having from 1 to 6 carbon atoms, a cycloalkyloxy group having from 5 to 6 carbon atoms, and an acyl group having from 1 to 4 carbon atoms.

Preferably, the substituents R₁ in formulae (II)-1 to (II)-4 are independently from each other hydrogen or an alkyl group having from 1 to 4 carbon atoms, more preferably all substituents R₁ are methyl.

Preferably, the substituents R₂ and R₃ in formulae (II)-1 to (II)-3 are, together with the carbon atom connecting them, a 12 membered cycloalkyl ring.

Preferably, the substituents R₄ and R₅ in formulae (II)-1 to (II)-4 are independently of one another selected from hydrogen, methyl, acetyl, octyloxy or cyclohexyloxy.

In a preferred embodiment the HALS component B is composed of the compounds according to formulae (II)-1 and (II)-2 and optionally (II)-3, wherein
n and m are independently of one another a number from 0 to 10, more preferably 0 to 5, with the proviso that n and m are not both 0;
R₁ is methyl;
R₂ and R₃ are, together with the carbon atom connecting, them a 12-membered cycloalkyl ring, and
R₄ is hydrogen.

In a more preferred embodiment the hindered amine light stabilizer B is composed of 85 to 95% by weight, based on component B, of at least one compound of formula (II)-1, 5 to 12% by weight, based on component B, of at least one compound of formula (II)-2, and 1 to 3% by weight, based on component B, of at least one compound of formula (II)-3, wherein
n and m are independently of one another a number from 0 to 10, more preferably 0 to 5, with the proviso that n and m are not both 0;
R₁ is methyl;
R₂ and R₃ are, together with the carbon atom connecting, them a 12-membered cycloalkyl ring, and
R₄ is hydrogen.

Typically, the oligomeric HALS component B1 has a (weight average) molecular weight of more than 540 g/mol, preferably more than 1,000 g/mol, in particular more than 1,500 g/mol. Preferably, the (weight average) molecular weight of the oligomeric HALS component B1 is ≤20.000 g/mol, preferably ≤18.000 g/mol, more preferably ≤17.000 g/mol. The (weight average) molecular weight of the oligomeric HALS component B1 is determined by gel permeation chromatography (GPC) using a mixture of tetrahydrofuran and diethanolamine as solvent and polystyrene with a molecular weight of 17.670 g/mol as standard.

The stabilizer component B, which is a mixture of oxadiaza-spirodecane compounds according to formulae (II)-1 and (II)-2 and optionally (II)-3 as defined above, is preferably obtained by reacting a polyalkyl-1-oxadiazaspirodecan with an epihalogenohydrin, in particular epichlorhydrin. The preparation of suitable stabilizers B is for example described in U.S. Pat. No. 4,340,534 and/or US 2005/228086.

In particular, the mixture of the oxadiaza-spirodecane compounds according to (II)-1, (II)-2 and (II)-3 is obtained by reacting compounds of general formula (II)-5:

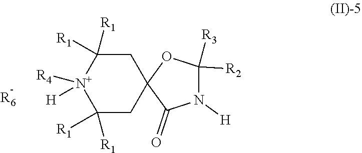

wherein the radicals R₁, R_{2,} R₃ and R₄ are as defined above, and R₆ is the anion of a protic acid of main group (V), (VI) or (VII) element, in particular a chloride anion;
with an epihalogenohydrin of the formula (II)-6:

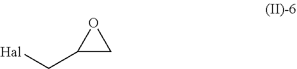

wherein Hal is halogen, being understood as meaning a chlorine, bromine or iodine atom, preferably chlorine.

Typically, in a first step a compound of formula (II)-3 is build, subsequent heating of the reaction mixture leads to the formation of the compounds of formulae (II)-1 and (II)-2. Preferably, the compounds (II)-5 and (II)-6 are reacted in a molar ratio of from 1:1 to 1:2.9; preferably from 1:1 to 1:2.7 and in particular from 1:2 to 1:2.5. In particular, the reaction takes place in an inert organic solvent in the presence of from four to twenty times the molar amount of alkali metal hydroxide relative to compounds of the formula (II)-5. Typically, the reaction temperature lies in the range from 20 to 220° C., preferably from 40 to 120° C., and in particular from 60 to 90° C.

Preferred inert organic solvents are aliphatic or aromatic hydrocarbons, such as petroleum ether, hexane, heptane, petroleum fractions, toluene, cyclohexane, mesitylene or xylene, for example. Particular preference is given to aromatic hydrocarbons, especially xylene. The inert organic solvent is preferably used in a weight ratio of from 2:1 to 1:5, more preferably from 2:1 to 1:3 and in particular from 2:1 to 1:2, relative to the compound (II)-5.

Typically, a phase transfer catalyst is used in the reaction. For example phase transfer catalysts used are polyethylene glycols, preferably polyethylene glycols with an average degree of oligomerization, and in particular polyethylene glycol 200, in a quantitative proportion of from 1.5 to 10% by weight, preferably from 3 to 7% by weight and in particular 4 to 6% by weight, relative to the amount of the compound of the formula (II)-5. For example, phase transfer catalysts used can be quaternary ammonium halides, such as tricaprylmethylammonium chloride, in particular in quantitative proportion of from 0.1 to 5% by weight, relative to the compound (II)-5.

The reaction of compounds (II)-5 and (II)-6 is generally over after from 30 to 60 minutes. Following the reaction, the excess of the epihalohydrin is removed from the reaction mixture, preferably by distillation. The organic and aqueous phases are separated; the organic phase is washed with water and the inert organic solvent is removed, preferably by distillation. The mixture obtained can be converted without a further purification step, by heating at from 100 to 240° C., preferably from 120 to 220° C. and in particular from 150 to 200° C., preferably under reduced pressure, into the desired mixture of the formulae (II)-1, (II)-2 and (II)-3.

By varying the amounts of the compounds of the formula (II)-5 used, the amount of epihalohydrin (II)-6, the amount of alkali metal hydroxide used and the amount of phase transfer catalyst employed, it is possible to adjust the composition of the mixture of components (II)-1, (II)-2 and (II)-3. The composition of the mixture of components (II)-1, (II)-2 and (II)-3 can be shown by conventional spectroscopic methods (IR and ¹³C-NMR spectroscopy).

In a particular preferred embodiment the HALS component B comprises (or preferably consists of) the reaction product of 2,2,4,4-tetramethyl-7-oxa-3,20-diazadispiro-20-(2,3-epoxi-propyl)dispiro-(5.1.11.2)-heneicosane-21-one and epichlorohydrin. Said reaction product is typically obtained as described above. Preferably said reaction product is obtained by reacting 2,2,4,4-tetramethyl-7-oxa-3,20-diazadispiro-20-(2,3-epoxi-propyl)dispiro-(5.1.11.2)-heneicosane-21-one and epichlorohydrin in a molar ratio of 1:2 to 1:2.5 in the presence of from four to twenty times the molar amount of alkali metal hydroxide relative to the molar amount of 2,2,4,4-tetramethyl-7-oxa-3,20-diazadispiro-20-(2,3-epoxi-propyl)dispiro-(5.1.11.2)-heneicosane-21-one, in an organic solvent using a phase transfer catalyst.

In one embodiment of the invention, the HALS component B exhibits a good solubility in common organic solvents and/or liquid constituents of the stabilizer composition. More preferably, the HALS component B exhibits a good solubility in the at least one liquid diluent D disclosed herein, in particular in liquid diluents D, selected from liquid plasticizers D1, liquid adhesion promoters D2, liquid catalysts D3, liquid moisture scavengers D4, and liquid solvents D5.

It was found that the solubility of the oligomeric HALS component B is beneficial for the performance of the stabilizer composition. SMP sealants and adhesives comprising the oligomeric HALS component B with good homogeneity are obtainable easily even at low temperatures, e.g. room temperature.

### Phenolic Antioxidant (Component C)

It was surprisingly found that the addition of a phenolic antioxidant in combination with the UV absorber A and the hindered amine light stabilizer B results in a further synergistic improvement of the stabilizer combination, in particular in view of heat stability, UV/weathering resistance and color.

Preferably, the antioxidant C is present in an amount of 1 to 50% by weight, preferably 1 to 30% by weight, more preferably 1 to 25% by weight, also preferably 2 to 17% by weight, in particular 5 to 16% by weight, based on a total stabilizer composition comprising components A, B and C. If the optional components D and E are present in the stabilizer composition, the antioxidant C is preferably present in an amount of 1 to 50% by weight, preferably 1 to 20% by weight, more preferably 1 to 15% by weight, also preferably 2 to 10% by weight, in particular 3 to 9% by weight, based on a total stabilizer composition comprising components A, B, C, D and E.

The inventive stabilizer composition comprises an antioxidant as component C, wherein the antioxidant is composed of one or more phenolic compounds according to the formulae (III)a and/or (III)b as shown above, wherein
Rₓ and R_{y} are independently of one another selected from hydrogen, halogen or an alkyl group having from 1 to 10, preferably 1 to 6, more preferably 1 to 4, carbon atoms;
R_{z} is selected from hydrogen or an alkyl group having from 1 to 10, preferably 1 to 6, more preferably 1 to 4, carbon atoms;
R_{w} is selected from a hydroxy group, an alkoxy group having from 1 to 18 carbon atoms, a phenyl alkoxy group having from 1 to 4 alkyl carbon atoms, a cycloalkoxy group having from 5 to 8 carbon atoms, or a group of formula (III)c

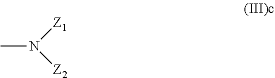

in which Z₁ and Z₂ are independently of one another selected from hydrogen, an alkyl group having from 1 to 18, preferably 1 to 10, carbon atoms, a phenyl group and a cycloalkyl group having from 5 to 8 carbon atoms;
X is selected from —O—(CH₂)_{q}—O—; —(OCH₂—CH₂)_{q}—O—; —O—(CH₂)_{q}—S—(CH₂)_{q}—O; —NH—(CH₂)_{q}—NH—; —NH—NH—, with q is an integer from 1 to 12, preferably 1 to 6, or a group

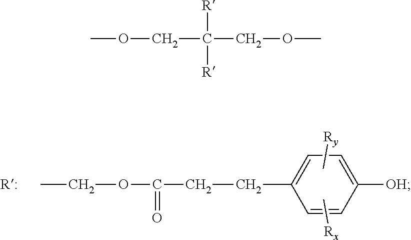

and p is zero or an integer from 1 to 6, preferably from 1 to 4.

In a preferred embodiment the phenolic antioxidant compounds C, used in the inventive stabilizer composition, does not include an amine group.

Preferably, Rₓ and R_{y} are independently of one another selected from a branched alkyl group having from 1 to 10, preferably 1 to 6, more preferably 1 to 4, carbon atoms. More preferably, one or both of Rₓ and R_{y} are a tert-butyl group.

Preferably, X is a group from —O—(CH₂)_{q}—O—, with q is an integer from 1 to 12, preferably 2 to 6, more preferably 2 to 4.

In a preferred embodiment, the antioxidant C is composed of one or more phenolic compounds according to the formulae (III)a′ and/or (III)b′:

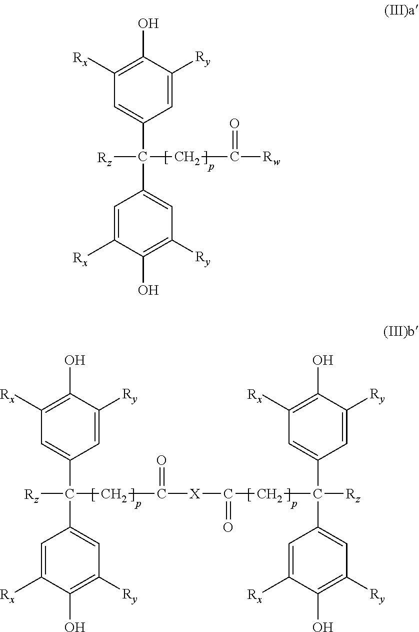

wherein the substituents and indices are as described above for formulae (III)a and (III)b.

In a preferred embodiment the antioxidant C comprises (or preferably consists of) a phenolic compound according to formula (III)b, or preferably (III)b′, wherein
Rₓ and R_{y} are independently of one another selected from a branched alkyl group having from 1 to 6, more preferably 1 to 4, carbon atoms, more preferably one or both of Rₓ and R_{y} are a tert-butyl group;
R_{z} is selected from hydrogen or an alkyl group having from 1 to 4 carbon atoms;
X is —O—(CH₂)_{q}—O— with q is an integer from 2 to 4; and
p is an integer from 1 to 4.

Preferred embodiments of the antioxidant component C are also described in U.S. Pat. No. 6,270,692 and/or GB 1 440 391, including: bis(4-hydroxy-phenyl)ethanoic acid, bis(4-hydroxy-3-methyl-phenyl)ethanoic acid, bis(4-hydroxy-3, 5-dimethyl-phenyl)ethanoic acid, bis(4-hydroxy-3-methyl-5-tert-butyl-phenyl)ethanoic acid, bis(4-hydroxy-3-methyl-phenyl)ethanoic acid ethyl ester, bis (4-hydroxy-3,5-dibromo-phenyl) ethanoic acid, bis(4-hydroxy-3,5-dibromo-phenyl) ethanoic acid n-butyl ester, bis(4-hydroxy-3,5-dimethyl-phenyl)ethanoic acid n-butyl ester, bis 4-hydroxy-3,5-di-tert-butyl-phenyl) ethanoic acid n-butyl ester, bis(4-hydroxy-3,5-di-tert-butyl-phenyl)ethanoic acid isopropyl ester, bis(4-hydroxy-3-tert-butyl-phenyl)ethanoic n-butyl amide, bis(4-hydroxy-3,5-di-tert-butyl-phenyl)ethanoic acid n-octyl amide, 4,4-bis(4′-hydroxy-3′-methyl-phenyl) butanoic acid, 2,2-bis(4′-hydroxy-3′-tert-butyl-phenyl) propanoic acid, 2,2-bis(4′-hydroxy-3′-tert-butyl-phenyl) propanoic acid n-butyl ester, 3,3-bis(4′-hydroxy-phenyl) butanoic acid, 3,3-bis(4′-hydroxy-3′-methyl-phenyl) butanoic acid methyl ester, 3,3-bis(4′-hydroxy-3′-tert-butyl-6′-methyl-phenyl) butanoic acid methyl ester, 3,3-bis(4′-hydroxy-3′-tert-butyl-phenyl) butanoic acid-cyclo-hexyl amide, 3,3-bis(4′-hydroxy-3′-tert-butyl-phenyl) pentanoic acid, 4,4-bis(4′-hydroxy-phenyl) pentanoic acid, 4,4-bis(4′-hydroxy-3′-methyl-phenyl) pentanoic acid, 4,4-bis(4′-hydroxy-3′-methyl-6′-tert-butyl-phenyl)-pentanoic acid, 4,4-bis(4′-hydroxy-3′-methyl-phenyl) pentanoic acid methyl ester, 4,4-bis(4′-hydroxy-3′-methyl-phenyl) pentanoic acid isopropyl ester, 4,4-bis(4′-hydroxy-3′-tert-butyl-phenyl)pentanoic acid methyl ester, 4,4-bis(4′-hydroxy-3′-tert-butyl-phenyl) pentanoic acid tert-butyl ester, 4,4-bis(4′-hydroxy-3′-tert-butyl-phenyl) pentanoic acid n-butyl amide, 4,4-bis(4′-hydroxy-3′-tert-butyl-phenyl) pentanoic acid diethyl amide, 4,4-bis(4′-hydroxy-3′-tert-butyl-phenyl) pentanoic acid amide, 4,4-bis(4′-hydroxy-3′-tert-butyl-phenyl) pentanoic acid cyclo-hexyl amide, bis[2,2-bis(4′-hydroxy-3′-methyl-phenyl) ethanoic acid] glycol ester, bis[2,2-bis(4′-hydroxy-3′-tert-butyl-phenyl) ethanoic acid] butanediol ester-(1,4), bis[2,2-bis(4′-hydroxy-3′,5′-di-tert-butyl-phenyl) ethanoic acid] glycol ester, bis[2,2-bis(4′-hydroxy-3′,5-di-tert-butyl-phenyl) ethanoic acid] hexane-diol ester(1,6), bis[3,3-bis(4′-hydroxy-3′-tert-butyl-phenyl) butanoic acid] butane diol ester-(1,4), bis[3,3-bis(4′-hydroxy-3′-tert-butyl-phenyl) butanoic acid] dodecane diol ester(1,12), bis[4,4-bis(4′-hydroxy-3′,5′-di-tert-butyl-phenyl)pentanoic acid] glycol ester, bis[4,4-bis(4′-hydroxy-3′-tert-butyl-phenyl) pentanoic acid] butane diol ester(1,4), bis[4,4-bis(4′-hydroxy-3′-tert-butyl-5′-bromo-phenyl)pentanoic acid] glycol ester, 3,3-bis(4′-hydroxy-3′-methyl-phenyl)butanoic acid, 3,3-bis(4′-hydroxy-3′-tert-butyl-phenyl)butanoic acid, bis(4′-hydroxy-3′,5′-di-tert-butyl-phenyl)ethanoic acid, bis(4′-hydroxy-3′-tert-butyl-phenyl)ethanoic acid, bis(4′-hydroxy-3′-tert-butyl-phenyl)ethanoic acid n-butyl ester, 3,3-bis(4′-hydroxy-3′-tert-butyl-phenyl)butanoic acid isopropyl ester, 3,3-bis(4′-hydroxy-3′-tert-butyl-phenyl)butanoic acid butyl ester, 3,3-bis(4′-hydroxy-3′-methyl-phenyl)butanoic acid n-butyl ester, 3,3-Bis(4′-hydroxy-3′-tert-butyl-phenyl)butanoic acid cyclohexyl ester, 3,3-Bis(4′-hydroxy-3′,5′-dimethyl-phenyl)butanoic acid dodecyl ester, bis[3,3-bis(4′-hydroxy-3-tert-butyl-phenyl)butanoic acid] 2,2-dimethyl-propane-diol-1,3-ester, 3,3-bis(4′-hydroxy-3′-tert-butyl-phenyl)butanoic acid benzyl ester, 3,3-bis(4′-hydroxy-3′-tert-butyl-phenyl)butanoic acid n-butylamide, 4,4-bis(4′-hydroxy-3′-tert-butyl-phenyl)pentanoic acid, 4,4-bis(4′-hydroxy-3′-tert-butyl-phenyl)pentanoic acid n-butyl ester, bis[3,3-bis(4′-hydroxy-3′-tert-butyl-phenyl)butanoic acid] glycol ester, bis[3,3-bis(4′-hydroxy-3′-tert-butyl-phenyl)butanoic acid] hexanedio1-1,6 ester, bis[4,4-bis(4′hydroxy-3′-tert-butyl-phenyl)pentanoic acid] glycol ester, 4,4-bis(4′-hydroxy-phenyl)pentanoic acid, bis[3,3-bis(4′-hydroxy-3′-tert-butyl-4′-bromophenyl)butanoic acid] glycol ester, 5,5-bis(4′-hydroxy-3′,5′-dimethyl-phenyl)hexanoic acid methyl ester and mixtures thereof.

In a preferred embodiment the antioxidant C comprises (or preferably consists of) a phenolic compound according to formula (III)-1, i.e. bis-(3,3-bis-(4′-hydroxy-3′-tert-butyl-phenyl)butanoic acid)-glycolester (CAS-No. 32509-66-3).

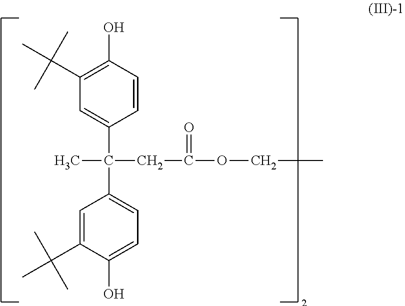

In a preferred embodiment of the inventive stabilizer composition the UV absorber A comprises (or preferably consists of) the (2-hydroxyphenyl)-s-triazine compounds according to formulae (I.1)-1 and/or (I.1)-2 and/or the oxalanilide compound according to formula (I.2)-1, and the antioxidant C comprises (or preferably consists of) the phenolic compound bis-(3,3-bis-(4′-hydoxy-3′-tert-butyl-phenyl)butanoic acid)-glycolester.

In a more preferred embodiment of the inventive stabilizer composition, the UV absorber A comprises (or preferably consists of) the oxalanilide compound according to formula (I.2)-1 and/or the (2-hydroxyphenyl)-s-triazine compounds according to formulae (I.1)-1 and/or (I.1)-2, the hindered amine light stabilizer B comprises (or preferably consists of) the reaction product of 2,2,4,4-tetramethyl-7-oxa-3,20-diazadispiro-20-(2,3-epoxi-propyl)dispiro-(5.1.11.2)-heneicosane-21-one and epichlorohydrin, and the antioxidant C comprises (or preferably consists of) the phenolic compound bis-(3,3-bis-(4′-hydoxy-3′-tert-butyl-phenyl)butanoic acid)-glycolester.

### Liquid Diluent (Component D)

In order to provide the inventive stabilizer composition in a preferred liquid form, liquid components A and/or B and optionally C may be used. However, it may be more convenient to provide a liquid stabilizer composition by the addition of a liquid diluent as component D, which is preferably chemically inert toward the components of the stabilizer composition, in particular the components A, B and optionally C The inventive stabilizer composition may therefore comprises one or more liquid diluents as component D. Preferably, the at least one liquid diluent D is present in an amount of from 30 to 79% by weight, preferably 35 to 69% by weight, more preferably 40 to 64% by weight, also preferably 40 to 55% by weight, in particular 43 to 53% by weight, based on the total stabilizer composition comprising the components A, B, optionally C, E and D. The amount is appropriately selected to provide a substantially liquid stabilizer composition in form of a solution, dispersion, emulsion, suspension, or paste, preferably a suspension

Preferably, the liquid diluent D can be selected from suitable liquid diluents, such as suitable solvents, liquid adjuvants or mixtures thereof. Preferably, the at least one liquid diluent D is selected from chemically inert solvents and liquid adjuvants, which are which may optionally be present (or typically are present) in a polymer composition based on a silyl-modified polymer (SMP).

In a preferred embodiment, the stabilizer composition comprises 35 to 69% by weight, preferably 40 to 64% by weight, more preferably 40 to 55% by weight, in particular 43 to 53% by weight, based on the total stabilizer composition, of at least one liquid diluent D, selected from liquid adjuvants and/or liquid solvents, as liquid diluent D.

In a preferred embodiment, the stabilizer composition comprises, as liquid diluent D, at least one liquid adjuvant and/or liquid solvent which may be present in a polymer composition based on a silyl-modified polymer (SMP), preferably comprising at least one liquid diluent D which is used as adjuvant in a polymer composition based on a silyl-modified polymer (SMP).

More preferably, the stabilizer composition comprises at least one liquid diluent D, selected from liquid plasticizers D1, liquid adhesion promoters D2, liquid catalysts D3, liquid moisture scavengers D4, and liquid solvents D5.

Preferred liquid plasticizers D1 are selected from phthalate ester plasticizer, such as dimethyl phthalate, diethyl phthalate, dibutyl phthalate, diheptyl phthalate, dioctyl phthalate, diisononyl phthalate, diisodecyl phthalate, di-isoundecyl phthalate, butylbenzyl phthalate, dilauryl phthalate and dicyclohexyl phthalate, epoxidized plasticizer, such as epoxidized soybean oil, epoxidized linseed oil and benzyl epoxy stearate; fatty acid esters, such as alkyl and phenyl esters of C₄-C₂₈ fatty acids, chlorinated paraffins and the like.

The plasticizer D1 may be one or a combination of two or more of the plasticizers mentioned above.

Preferably, the plasticizer D1 is free of phthalate compounds. Preferably, the plasticizer D1 comprises (or preferably is composed of) at least one C₁₀-C₂₁ alkanesulfonic acid phenylester (e.g. available as Mesamoll® from Lanxess).

Preferably, the at least one adhesion promoter D2 is selected from silane compounds having at least one additional functional group, e.g. selected from amino group, mercapto group, epoxy group, carboxyl group, vinyl group, isocyanate group, isocyanurate, halogen and the like. Typically, the adhesion promoter D2 is selected from epoxysilane, and aminosilane.

For example, the adhesion promoter D2 may be selected from:
isocyanato group-containing silanes such as γ-isocyanatopropyltrimethoxysilane, γ-isocyanatopropyltriethoxysilane, γ-isocyanatopropylmethyldiethoxysilane and γ-isocyanatopropylmethyldimethoxysilane;
amino group-containing silanes, for example selected from γ-aminopropyl trimethoxysilane, γ-aminopropyltriethoxysilane, γ-aminopropylmethyldimethoxysilane, γ-aminopropylmethyldiethoxysilane, γ-(2-aminoethyl)aminopropyl trimethoxysilane, γ-(2-aminoethyl)aminopropyl methyldimethoxysilane, γ-(2-aminoethyl)aminopropyl triethoxysilane, γ-(2-aminoethyl)aminopropyl methyldiethoxysilane, γ-ureidopropyl trimethoxysilane, N-phenyl-γ-aminopropyltrimethoxysilane, N-benzyl-γ-aminopropyltrimethoxysilane and N-vinylbenzyl-γ-aminopropyltriethoxysilane;
mercapto group-containing silanes, such as γ-mercaptopropyltrimethoxysilane, γ-mercaptopropyltriethoxysilane, γ-mercaptopropylmethyldimethoxysilane and γ-mercaptopropylmethyldiethoxysilane;
epoxy group-containing silanes, such as γ-glycidoxypropyl trimethoxysilane, γ-glycidoxypropyl triethoxysilane, γ-glycidoxypropyl methyldimethoxysilane, β-(3,4-epoxycyclohexyl)ethyl trimethoxysilane and β-(3,4-epoxycyclohexyl) ethyltriethoxysilane;
carboxysilanes, such as β-carboxyethyltriethoxysilane, β-carboxyethylphenylbis-(2-methoxyethoxy)silane and N-β-(carboxymethyl)aminoethyl-γ-aminopropyl trimethoxysilane;
halogen-containing silanes, such as γ-chloropropyltrimethoxysilane; and isocyanurate silanes such as tris(trimethoxysilyl) isocyanurate.

In a preferred embodiment the at least one adhesion promoter D2 is selected from aminogroup-containing silanes, in particular aminogroup-containing trimethoxysilanes. Preferably, the at least one adhesion promoter D2 comprises at least one aminogroup-containing trimethoxysilane, preferably 3-aminopropyltrimethoxysilane (e.g. Dynasylan® AMMO from Evonik).

In a preferred embodiment the at least one D3 is selected from commonly known silanol condensation catalyst. Such condensing catalyst may be for example tetravalent tin compounds such as dibutyltin dilaurate, dibutyltin diacetate, dibutyltin; divalent tin compounds such as stannous octylate; titanate esters such as tetrabutyl titanate and tetrapropyl titanate; amine compounds such as butylamine, octylamine, laurylamine, dibutylamine, monoethanolamine, diethanolamine, triethanolamine, diethylenetriamine, triethylenetetramine, cyclohexylamine, benzylamine, diethylaminopropylamine, xylylenediamine, 2,4,6-tris(dimethylaminomethyl)phenol, morpholine, N-methylmorpholine, and 1,8-diazabicyclo[5.4.0]undecene-7 (DBU); amino group-containing silane coupling agents such as γ-aminopropyltrimethoxysilane and N-(6-aminoethyl)aminopropylmethyl-dimethoxysilane; and like silanol condensation catalysts and, further, other known silanol condensation catalysts such as acidic catalysts and basic catalysts.

The catalysts D3 may be one or a combination of two or more of catalysts mentioned above.

Preferably, the at least one catalyst D3 is selected from metal organic compounds based on tetravalent titanium (such as di-isopropoxy titanium bis-acetylacetonat) and/or organic compounds based on tetravalent tin (such as di-alkyl tin bis acetylacetonate compounds, and di-alkyl tin phthalate esters). Such catalysts are for example available from TIB Chemicals. Preferably, the catalyst D3 comprises at least one organotin compound, more preferably dibutyltin bis-acetylacetonat and/or dioctyltin bis-acetylacetonat (e.g. TIB KAT® 223 from TIB Chemicals, dioctyltindiketanoat).

Preferably, the moisture scavenger D4 is selected from liquid vinylsilanes, in particular vinyl type unsaturated group-containing silanes, such as vinyltrimethoxysilane (VTMO), vinyltriethoxysilane (VTEO), γ-methacryloyloxypropyl-methyldimethoxysilane and γ-acryloxyloxypropylmethyltriethoxysilane. For example, the moisture scavenger D4 is vinyltrimethoxysilane (VTMO) (e.g. Dynasylan® VTMO from Evonik) and/or vinyltriethoxysilane (VTEO) (e.g. Dynasylan® VTEO from Evonik). In a particular preferred embodiment of the invention, the liquid diluent D comprises (or consists of) at least one moisture scavenger D4, more preferably vinyltrimethoxysilane (VTMO) (e.g. Dynasylan® VTMO from Evonik) and/or vinyltriethoxysilane (VTEO) (e.g. Dynasylan® VTEO from Evonik), most preferably vinyltrimethoxysilane (VTMO).

Preferably, the solvent D5 is selected from inert, polar or inert, apolar, organic solvents, which are commonly used in the art.

In one embodiment, the stabilizer composition comprises at least one inert solvent, in particular at least one inert, polar solvent. Suitable polar solvents comprise ethers, glycol ethers, acetates such as ethyl acetate, alcohols such as ethanol and n-butanol, and in particular methoxypropanol.

In an alternative embodiment, the stabilizer composition may comprise inert, apolar organic solvents, preferably aliphatic or aromatic hydrocarbons, such as petroleum ether, hexane, heptane, petroleum fractions, toluene, cyclohexane, mesitylene or xylene, for example.

In one embodiment of the invention, the stabilizer composition may be free of substantial amounts of solvents, which may be harmful to health and/or environment. In particular, the require classification the stabilizer composition may be free of substantial amounts of solvents, which require classification as hazardous according to current EU regulations for Classification, Labeling and Packaging of Chemical Substances (CLP). According to one aspect of the invention, the stabilizer composition may be free of substantial amounts of aromatic hydrocarbon solvents, such as toluene, mesitylene or xylene. In one embodiment of the invention, the stabilizer composition is free of substantial amounts of toluene. In one embodiment of the invention, the stabilizer composition is free of substantial amounts of mesitylene. In one embodiment of the invention, the stabilizer composition is free of substantial amounts of xylene. For the purposes of the present invention, the term “substantial amounts” is to be understood as amounts of ≥1% by weight, based on the total stabilizer composition.

In a preferred embodiment of the invention, the liquid diluent D comprises (or consists of) at least one component, selected from at least one liquid plasticizer D1, at least one liquid moisture scavenger D4, at least one liquid solvent D5 and mixtures of the afore mentioned compounds.

In a further preferred embodiment, the liquid diluent D comprises (or consists of) at least one component, selected from at least one liquid moisture scavenger D4, in particular vinyltrimethoxysilane, at least one liquid solvent D5, in particular methoxypropanol and/or xylene, and mixtures of the afore mentioned compounds.

### Further Additive (Component E)

The inventive stabilizer composition may further comprise one or more further additives E as an optional component, such as common additives for stabilizer composition and SMP sealants and adhesives.

Preferably, the at least one additive E may be present in an amount of from 0 to 50% by weight, preferably 0 to 20% by weight, more preferably 0.01 to 20% by weight, also preferably 0.01 to 10% by weight, also preferably 0.1 to 1% by weight, based on the total stabilizer composition.

The further additive E can be selected from common additives, such as antistatic agents, flame proofing agents, softeners, nucleating agents, metal deactivators, biocides, impact modifiers, fillers, pigments and fungicides, bactericides. Further, one or more additives mentioned as additives G below may be used in the inventive stabilizer composition, with the provision that the additive E is different from the liquid diluent D.

### Process for Preparing the Stabilizer Composition

The present invention is also directed to a process for preparing the inventive stabilizer composition, wherein the components A, B, and optionally C, D and/or E are mixed. In particular, the mixing can be carried out by mixing the components A, B, and optionally C, D and/or E in liquid form, in particular in form of a solution, dispersion, emulsion, suspension, or paste, preferably a suspension or solution, in particular a solution.

Preferably, the process for preparing the inventive stabilizer composition may encompass a step of milling one or more of the components A, B, and optionally C and/or E. Subsequently, the components A, B, and optionally C, D and/or E may be mixed. Preferably, the stabilizer composition can be obtained, e.g. by a milling step (e.g. micronisation), in form of a suspension comprising solid particles having a particle size d₅₀ in the range of 10 to 1000 μm. The milling step may break up agglomerates and improve the even distribution of non-liquid components A, B, and optionally C and E

In a further embodiment the process for preparing the stabilizer composition encompasses a step of dispersing or dissolving at least one solid component, selected from components A, B, and optionally C and/or E, in a liquid, wherein the liquid may be the at least one liquid diluent D and/or one or more of the components A, B, C, or E in liquid form. For example, one or more of the components A, B C or E may be provided in dispersed or dissolved from, e.g. in combination with a liquid diluent D, and subsequently mixed with the further components of the stabilizers composition.

Further, the invention is directed to the use of the inventive stabilizer composition as stabilizer in sealants or adhesives based on silyl-modified polymers. In particular, the inventive stabilizer composition is used to improve UV and heat stability of sealants or adhesives based on silyl-modified polymers, i.e. resistance against decrease of mechanical and/or optical surface properties under exposure to UV radiation and/or heat.

### Polymer Composition

Furthermore, the present invention is directed to a polymer composition based on a silyl-modified polymer (SMP) comprising the described stabilizer combination of UV absorber A, hindered amine light stabilizer B and phenolic antioxidant C as described above. The present invention is directed to a polymer composition comprising
(P) at least one polymer P selected from silyl-modified polymers;
(S) a stabilizer combination S composed of
   at least one UV absorber A;
   at least one hindered amine light stabilizer B;
   optionally at least one phenolic antioxidant C; optionally at least one liquid diluent D; and
   optionally at least one further additive E;
   wherein the components A, B, C, D and E are as defined for the inventive stabilizer composition;
(F) optionally at least one filler F;
(G) optionally at least one further additive G, preferably selected from plasticizers G1, adhesion promoters G2, catalysts G3 and moisture scavengers G4.

In a preferred embodiment, the invention is directed to a polymer composition comprising (or preferably consisting of):
(P) 5 to 99% by weight, preferably 10 to 80% by weight, more preferably 15 to 40% by weight, based on the total polymer composition, of the at least one polymer P selected from silyl-modified polymers;
(S) a stabilizer combination S composed of
   0.001 to 3% by weight, preferably 0.01 to 1% by weight, more preferably 0.1 to 0.8% by weight, based on the total polymer composition, of the at least one UV absorber A;
   0.001 to 3% by weight, preferably 0.01 to 1% by weight, more preferably 0.1 to 0.8% by weight, based on the total polymer composition, of the at least one hindered amine light stabilizer B;
   0 to 3% by weight, preferably 0.01 to 1% by weight, more preferably 0.05 to 0.3% by weight, based on the total polymer composition, of the at least one phenolic antioxidant C;
   0 to 3% by weight, preferably 0.01 to 2% by weight, more preferably 0.1 to 1.6% by weight, based on the total polymer composition, of the at least one liquid diluent D; and
   0 to 3% by weight, preferably 0.01 to 1% by weight, more preferably 0.05 to 0.3% by weight, based on the total polymer composition, of the at least one further additive E;
(F) 0 to 85% by weight, preferably 0 to 80% by weight, more preferably from 1 to 70% by weight, based on the total polymer composition, of at least one filler F, preferably selected from calcium carbonate;
(G) 0 to 35% by weight, preferably 0 to 33% by weight, more preferably from 1 to 30% by weight, based on the total polymer composition, of at least one further additive G, preferably selected from plasticizers G1, adhesion promoters G2, catalysts G3 and moisture scavengers G4.

In case that the optional components F and/or G are present the amount of the component P may be adapted in that the sum of the amounts is or does not exceed 100% by weight. If the liquid diluent D comprises a liquid diluent D that may also serve as active ingredient of an additive G, the amount of G may be accordingly reduced to keep the total amount of the additive G in the above-mentioned range.

The preferred embodiments of the components A, B, C and D as described above applies to the inventive polymer composition as well.

In a preferred embodiment, the polymer composition comprises (or preferably consists of):
(P) 7.5 to 95% by weight, preferably 12.5 to 72% by weight, more preferably 17 to 57% by weight, based on the total polymer composition, of the at least one polymer P selected from silyl-modified polymers;
(S) a stabilizer combination S composed of
   0.001 to 3% by weight, preferably 0.01 to 1% by weight, more preferably 0.1 to 0.8% by weight, based on the total polymer composition, of the at least one UV absorber A;
   0.001 to 3% by weight, preferably 0.01 to 1% by weight, more preferably 0.1 to 0.8% by weight, based on the total polymer composition, of the at least one hindered amine light stabilizer B;
   0 to 3% by weight, preferably 0.01 to 1% by weight, more preferably 0.05 to 0.3% by weight, based on the total polymer composition, of the at least one phenolic antioxidant C;
   0 to 3% by weight, preferably 0.01 to 2% by weight, more preferably 0.1 to 1.6% by weight, based on the total polymer composition, of the at least one liquid diluent D; and
   0 to 3% by weight, preferably 0.01 to 1% by weight, more preferably 0.05 to 0.3% by weight, based on the total polymer composition, of the at least one further additive E;
(F) 1 to 90% by weight, preferably 20 to 80% by weight, more preferably 30 to 70% by weight, based on the total polymer composition, of at least one filler F;
(G1) 1 to 25% by weight, preferably 5 to 25% by weight, more preferably from 10 to 20% by weight, based on the total polymer composition, of at least one plasticizer as further additive G1;
(G2) 0.5 to 5% by weight, preferably 0.7 to 3% by weight, more preferably from 0.8 to 2% by weight, based on the total polymer composition, of at least one adhesion promoter as further additive G2;
(G3) 0.01 to 3% by weight, preferably 0.1 to 2% by weight, more preferably from 0.2 to 1% by weight, based on the total polymer composition, of at least one catalyst as further additive G3;
(G4) 0.5 to 5% by weight, preferably 0.7 to 5% by weight, more preferably from 0.8 to 3% by weight, based on the total polymer composition, of at least one moisture scavenger as further additive G4;
(G) and 0 to 10% by weight, based on the total polymer composition, of at least one further additive G different from G1 to G4.

In a preferred embodiment the components P, S, F and G sum up to 100% by weight, wherein in particular the amount of the components P and/or F can be adapted.

In particular, the inventive polymer composition can be obtained using an inventive stabilizer composition as described above. In particular, the polymer composition comprises from 0.01 to 10% by weight, preferably 0.1 to 6% by weight, more preferably 0.2 to 3% by weight, in particular 1.6 to 2.4% by weight, based on the total polymer composition, of the inventive stabilizer composition.

### Silyl-Modified Polymer P

Typically, the silyl-modified polymer P is selected from organic polymers, in particular based on polyethers, polyurethanes, and/or acrylic polymers, having at least one, preferably two terminal, cross-linkable hydrolysable silyl group. Preferably, the terminal cross-linkable hydrolysable silyl groups are the only cross-linkable hydrolysable silyl group in the silyl-modified polymer P.

For example suitable silyl-modified polymers P are the commercial products Kaneka MS Polymers® (such as MS Polymer® S203H, MS Polymer® S303H) or Polymer ST from Evonik, which are silyl-modified polymers including polyether and polyurethane blocks, or polymers available from The Dow Chemical Company under the tradename VORASIL®, which are silyl-modified polymers having a polyurethane polymer backbone.

The polymerization methods for preparing silyl-modified polymers are commonly known in the art and for example described in U.S. Pat. No. 3,971,751 and EP-A 1 288 247.

In particular, the cross-linkable hydrolysable silyl group can be described by the following formula (P-I):

—SiYₐR^{Q}₃₋ₐ (P-I)
wherein
   R^{Q} is selected from an alkyl group having from 1 to 20 carbon atoms, an aryl group having from 6 to 20 carbon atoms and an aralkyl group having from 7 to 20 carbon atoms,
   Y is a hydroxyl group or a hydrolysable group;
   a is 1, 2 or 3, and if two or more groups R^{Q} or Y are present, they may be the same or different.

For example the hydrolysable group Y can be selected from hydrogen, a halogen atom, an alkoxy group having from 1 to 20 carbon atoms, preferably a methoxy group or a ethoxy group, an acyl oxide group, a ketoximate group, an amino group, an amide group, an acid amide group, an aminooxy group, a mercapto group. Preferably, the hydrolysable group Y is selected from alkoxy groups, in particular methoxy and ethoxy.

The at least one silyl-modified polymer P may comprise one or more silyl-modified polyurethanes and/or silyl-modified polyurethane/polyether copolymers comprising at least one cross-linkable hydrolysable silyl group. In particular, the silyl-modified urethane polymer may for example be derived from the reaction of an aromatic polyisocyanate, such as toluene diisocyanate, diphenylmethane diisocyanate or xylylene diisocyanate or an aliphatic polyisocyanate (e.g. isophorone diisocyanate or hexamethylene diisocyanate) with a polyol.

In a preferred embodiment the at least one silyl-modified polymer P comprises (or preferably consist of) at least silyl-modified polyether. Typically, silyl-modified polyethers encompass a polyether main chain modified by at least one cross-linkable hydrolysable silyl group, more preferably by two terminal cross-linkable hydrolysable silyl groups. For example, the polyether main chain may include repeating units selected from polyethylene oxide, polypropylene oxide, polybutylene oxide and/or polyphenylenoxid. Further, the polyether may contain a urethane bond or urea bond in the main chain. Preferably, the silyl-modified polyether comprises polyethylene oxide repeating units in the polyether main chain, wherein preferably at least 50% by weight, preferably at least 70% by weight, more preferably at least 90% by weight, of the repeating units are polyethylene oxide repeating units. Preferred silyl-modified polyethers having two terminal cross-linkable hydrolysable silyl groups are for example described in U.S. Pat. No. 3,971,751 and US 2002/198308.

In a preferred embodiment, the silyl-modified polymer P is selected from silyl-modified polyethers according to the following formula (P-II):

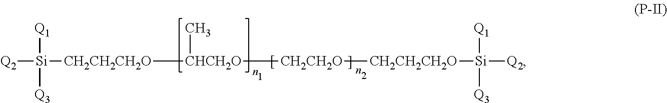

wherein
Q₁, Q₂ and Q₃ are independently from each other selected from an alkyl group having 1 to 40, preferably 1 to 20, more preferably 1 to 4, carbon atoms, an alkyoxy group having from 1 to 10, preferably 1 to 4 carbon atoms, such as methoxy or ethyoxy, and acetyloxy, with the proviso that at least one of Q₁, Q₂ and Q₃ is a cross-linkable hydrolysable silyl group, preferably selected from methoxy, ethoxy, and acetyloxy, and n₁ and n₂ are independently from each other a integer from 0 to 1000, preferably 0 to 500, more preferably 0 to 300, with the proviso that n₁+n₂ is at least 50, preferably at least 100.

In a more preferred embodiment, the silyl-modified polymer P is selected from silyl-modified polyethers according to the following formulae (P-III) and (P-IV):

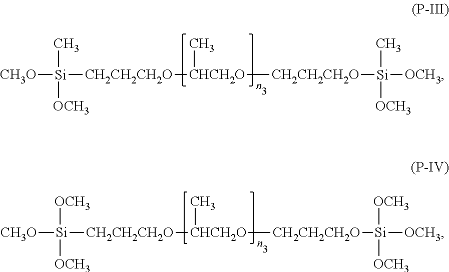

wherein n₃ is an integer from 5 to 1000, preferably 10 to 500, more preferably 20 to 500, also preferably 50 to 300.

Preferably, the molecular weight of the polyether main chain of the silyl modified polyether, e.g. as described in formulae (P-I) to (P-III), is in the range of 500 to 30,000 g/mol, preferably 1,000 to 15,000 g/mol, more preferably 3,000 to 12,000 g/mol.

Preferably, one or more di-methoxysilyl terminated polyether (DMS MS) and/or tri-methoxysilyl terminated polyether (TMS MS) are used as silyl-modified polymer P. More preferably, one or more di-methoxysilyl terminated polyether (DMS MS) is used as polymer P. More particular a methyl di-methoxysilyl terminated polyether is used.

Typically, the silyl-modified polyethers, preferably having two terminal cross-linkable hydrolysable silyl group, used as polymer P has a molecular weight (in particular a number average molecular weight) in the range of from about 1,000 to 50,000 g/mol, preferably about 5,000 to about 40,000 g/mol, more preferably from about 8,000 to about 35,000 g/mol, more preferably from about 10,000 to about 30,000 g/mol.

Typically, the silyl-modified polyethers, preferably having two terminal cross-linkable hydrolysable silyl group, used as polymer P exhibits a viscosity in the range of from about 1 to about 50 Pa s, preferably from about 3 to about 40 Pa s, more preferably from about 5 to about 30 Pa s, more preferably from about 7 to about 20 Pa s. Typically, the viscosity is measured using a Brookfield viscosimeter. For example, the Brookfield viscosity (specified in mPa·s) is measured by a Brookfield DV III Ultra viscometer at 24° C.±3° C. at 100 rpm using an appropriate spindle suitable for the viscosity range to be measured, e.g. selected from the Brookfield RV-spindle set (typically spindle No. 7). Typically, once the spindle is inserted into the sample, the measurement is started with a constant rotating speed of 100 rpm. The reported Brookfield viscosity values are the values displayed 60 seconds after the start of the measurement.

In a preferred embodiment the silyl-modified polymer P comprises (or preferably consist of) at least one silyl-modified polyether having two terminal methyl dimethoxysilyl groups (e.g. Kaneka MS polymer® S203H and/or Kaneka MS polymer® S303H).

### Filler F

Preferably, the inventive polymer composition comprises at least one filler F in an amount of from 1 to 90% by weight, preferably 20 to 80% by weight, more preferably 30 to 70% by weight, based on the total polymer composition.

Preferably, the at least one filler F is selected from wood meal, walnut shell flour, rice hull flour, pulp, cotton chips, mica, graphite, diatomaceous earth, china clay, kaolin, clay, talc, silica, fumed silica, precipitated silica, silicic anhydride, quartz powder, glass beads, calcium carbonate (e.g. chalk), magnesium carbonate, titanium oxide, ferric oxide, zinc oxide, carbon black, glass balloons, glass fibers and carbon fibers. The filler F may be one or a combination of two or more of the fillers mentioned above. Preferably, the at least one filler is selected from calcium carbonate, silica, carbon black, and combinations thereof. Suitable fillers are also described in U.S. Pat. No. 6,077,896 and EP 1 288 247.

Preferably, the at least one filler F is calcium carbonate, in particular one or more calcium carbonate selected from chalk, marble, limestone, precipitated calcium carbonate (PCC), coated precipitated calcium carbonate, ground calcium carbonate (GCC) (in particular GCC based on chalk, marble and/or limestone) and coated ground calcium carbonate. For example, PCC and/or GCC coated with fatty acids can be used as filler F.

Preferably, the filler F comprises (or preferably is composed of) at least one calcium carbonate, in particular at least one precipitated calcium carbonate coated with fatty acids.

### Additives G

In a preferred embodiment, the inventive polymer composition comprises at least one additive G selected from plasticizers G1, adhesion promoters G2, catalysts G3, moisture scavengers G4 and other commonly known additives for SMP sealants. Preferably, the inventive polymer composition comprises at least one plasticizer G1, at least one adhesion promoter G2, at least one catalyst G3, and at least one moisture scavenger G4, as additives G.

Such typical additives for SMP sealants and adhesives are for example described in U.S. Pat. No. 6,077,896, EP-A 1 288 247 and US 2003/105261.

Preferably, the inventive polymer composition comprises at least one plasticizer G1 in an amount of from 1 to 25% by weight, preferably 5 to 25% by weight, more preferably from 10 to 20% by weight, based on the total polymer composition.

Preferably, the at least one plasticizer G1 is selected from phthalate ester plasticizer, such as dimethyl phthalate, diethyl phthalate, dibutyl phthalate, diheptyl phthalate, dioctyl phthalate, diisononyl phthalate, diisodecyl phthalate, di-isoundecyl phthalate, butylbenzyl phthalate, dilauryl phthalate and dicyclohexyl phthalate, epoxidized plasticizer, such as epoxidized soybean oil, epoxidized linseed oil and benzyl epoxy stearate; fatty acid esters, such as alkyl and phenyl esters of C₄-C₂₈ fatty acids, polyester plasticizers derived from dibasic acids and dihydric alcohols, polyether, such as polypropylene glycol and derivatives thereof; polystyrenes, such as poly-α-methylstyrene and polystyrene; polybutadiene, butadiene-acrylonitrile copolymers, polychloroprene, polyisoprene, polybutene, chlorinated paraffins and the like.

The plasticizer G1 may be one or a combination of two or more of the plasticizers mentioned above.

Preferably, the plasticizer G1 is free of phthalate compounds. Preferably, the plasticizer G1 comprises (or preferably is composed of) at least one C₁₀-C₂₁ alkanesulfonic acid phenylester (e.g. available as Mesamoll® from Lanxess).

Preferably, the inventive polymer composition comprises at least one adhesion promoter G2 in an amount of from 0.5 to 5% by weight, preferably 0.7 to 3% by weight, more preferably from 0.8 to 2% by weight, based on the total polymer composition.

Preferably, the at least one adhesion promoter G2 is selected from silane compounds having at least one additional functional group, e.g. selected from amino group, mercapto group, epoxy group, carboxyl group, vinyl group, isocyanate group, isocyanurate, halogen and the like. Typically, the adhesion promoter G2 is selected from epoxysilane, and aminosilane.

For example, the adhesion promoter G2 may be selected from:
isocyanato group-containing silanes such as γ-isocyanatopropyltrimethoxysilane, γ-isocyanatopropyltriethoxysilane, γ-isocyanatopropylmethyldiethoxysilane and γ-isocyanatopropylmethyldimethoxysilane;
amino group-containing silanes, for example selected from γ-aminopropyl trimethoxysilane, γ-aminopropyltriethoxysilane, γ-aminopropylmethyldimethoxy-silane, γ-aminopropylmethyldiethoxysilane, γ-(2-aminoethyl)aminopropyl trimethoxysilane, γ-(2-aminoethyl)aminopropyl methyldimethoxysilane, γ-(2-aminoethyl)aminopropyl triethoxysilane, γ-(2-aminoethyl)aminopropyl methyldiethoxysilane, γ-ureidopropyl trimethoxysilane, N-phenyl-γ-aminopropyltrimethoxysilane, N-benzyl-γ-aminopropyltrimethoxysilane and N-vinylbenzyl-γ-aminopropyltriethoxysilane;
mercapto group-containing silanes, such as γ-mercaptopropyltrimethoxysilane, γ-mercaptopropyltriethoxysilane, γ-mercaptopropylmethyldimethoxysilane and γ-mercaptopropylmethyldiethoxysilane;
epoxy group-containing silanes, such as γ-glycidoxypropyl trimethoxysilane, γ-glycidoxypropyl triethoxysilane, γ-glycidoxypropyl methyldimethoxysilane, β-(3,4-epoxycyclohexyl)ethyl trimethoxysilane and β-(3,4-epoxycyclohexyl) ethyltriethoxysilane;
carboxysilanes, such as β-carboxyethyltriethoxysilane, β-carboxyethylphenylbis-(2-methoxyethoxy)silane and N-β-(carboxymethyl)aminoethyl-γ-aminopropyl trimethoxysilane;
halogen-containing silanes, such as γ-chloropropyltrimethoxysilane; and isocyanurate silanes such as tris(trimethoxysilyl) isocyanurate.

In a preferred embodiment the at least one adhesion promoter G2 is selected from aminogroup-containing silanes, in particular aminogroup-containing trimethoxysilanes. Preferably, the at least one adhesion promoter G2 comprises at least one aminogroup-containing trimethoxysilane, preferably 3-aminopropyltrimethoxysilane (e.g. Dynasylan® AMMO from Evonik).

Preferably, the inventive polymer composition comprises at least one catalyst G3 in an amount of from 0.01 to 3% by weight, preferably 0.1 to 2% by weight, more preferably from 0.2 to 1% by weight, based on the total polymer composition.

Typically, the at least one catalyst G3 is selected from commonly known silanol condensation catalyst. Suitable catalyst G3 are for example described in U.S. Pat. No. 6,077,896 and EP 1 288 247.

Such condensing catalyst may be for example tetravalent tin compounds such as dibutyltin dilaurate, dibutyltin phthalate, dibutyltin bisacetylacetonate, dibutyltin diacetate, dibutyltin diethylhexanolate, dibutyltin dioctoate, dibutyltin di(methyl maleate), dibutyltin di(ethyl maleate), dibutyltin di(butyl maleate), dibutyltin di(isooctyl maleate), dibutyltin di(tridecyl maleate), dibutyltin di(benzyl maleate), dibutyltin maleate, dioctyltin diacetate, dioctyltin distearate, dioctyltin dilaurate, dioctyltin di(ethyl maleate), dioctyltin di(isooctyl maleate), dibutyltin dimethoxide, dibutyltin bisnonylphenoxide and dibutenyltin oxide; divalent tin compounds such as stannous octylate, stannous naphthenate and stannous stearate; titanate esters such as tetrabutyl titanate and tetrapropyl titanate; organoaluminum compounds such as aluminum trisacetylacetonate, aluminum tris(ethyl acetoacetate) and diisopropoxyaluminum ethyl acetoacetate; chelate compounds such as zirconium tetraacetylacetonate and titanium tetraacetylacetoante; lead octylate; amine compounds such as butylamine, octylamine, laurylamine, dibutylamine, monoethanolamine, diethanolamine, triethanolamine, diethylenetriamine, triethylenetetramine, oleylamine, cyclohexylamine, benzylamine, diethylaminopropylamine, xylylenediamine, triethylenediamine, guanidine, diphenylguanidine, 2,4,6-tris(dimethylaminomethyl)phenol, morpholine, N-methylmorpholine, 2-ethyl-4-methylimidazole and 1,8-diazabicyclo[5.4.0]undecene-7 (DBU), or salts of these amine compounds with carboxylic acids; amine compound-organotin compound reaction products and mixtures, for example laurylamine-stannous octylate reaction products or mixtures; low-molecular-weight polyamide resins obtainable from a polyamine in excess and a polybasic acid; reaction products from a polyamine in excess and an epoxy compound; amino group-containing silane coupling agents such as γ-aminopropyltrimethoxysilane and N-(β-aminoethyl)aminopropylmethyl-dimethoxysilane; and like silanol condensation catalysts and, further, other known silanol condensation catalysts such as acidic catalysts and basic catalysts.

The catalysts G3 may be one or a combination of two or more of catalysts mentioned above.

Preferably, the at least one catalyst G3 is selected from metal organic compounds based on tetravalent titanium (such as di-isopropoxy titanium bis-acetylacetonat) and/or organic compounds based on tetravalent tin (such as di-alkyl tin bis acetylacetonate compounds, and di-alkyl tin phthalate esters). Such catalysts are for example available from TIB Chemicals. Preferably, the catalyst G3 comprises at least one organotin compound, more preferably dibutyltin bis-acetylacetonat and/or dioctyltin bis-acetylacetonat (e.g. TIB KAT® 223 from TIB Chemicals, dioctyltindiketanoat).

Preferably, the inventive polymer composition comprises at least one moisture scavenger D in an amount of from 0.5 to 5% by weight, preferably 0.7 to 5% by weight, more preferably from 0.8 to 3% by weight, based on the total polymer composition.

Preferably, the moisture scavenger G4 is selected from vinylsilanes, in particular vinyl type unsaturated group-containing silanes, such as vinyltrimethoxysilane (VTMO), vinyltriethoxysilane (VTEO), γ-methacryloyloxypropylmethyldimethoxysilane and γ-acryloxyloxypropylmethyltriethoxysilane. For example, the moisture scavenger G4 is vinyltrimethoxysilane (VTMO) (e.g. Dynasylan® VTMO from Evonik) and/or vinyltriethoxysilane (VTEO) (e.g. Dynasylan® VTEO from Evonik).

Further, the polymer composition may comprise 0 to 10% by weight of at least further additive G, different from G1, G2, G3 and G4 as well as different from A, B, C and C, such as compatibilizers, tackifiers, physical property modifiers, storage stability improving agents, metal deactivators, antiozonants, light stabilizers, heat stabilizers, phosphorus-containing peroxide decomposers, lubricants, pigments (such as TiO₂ and carbon black), thixotropic agents (such as polyamide waxes, fumed silica, hydrogenated castor oil), foaming agents, flame retardants and antistatic agents, each in an adequate amount.

Furthermore, the present invention also encompasses a process for preparing the inventive polymer composition, wherein the process comprises mixing the components P and S and optionally F and/or G.

Several processes for preparing SMP sealants are known and described in the state of the art. Typically, the preparation process comprises mixing of the components mentioned above in arbitrary order and kneading the resulting mixture at ordinary temperature or with heating using a mixer, roller, kneader, or the like. The composition can be prepared, for example, by adding the compounds A, B, C, D, and optionally F and G to the silyl-modified polymer P and effecting uniform dispersion and dissolution, if necessary, adjusting the heating and stirring conditions, for instance. Typically, the mixing of the components is carried out in a known apparatus, such as a kneader (planetary mixer), multi-shaft mixer with vacuum and heating system. Further, the preparation process may encompass dissolving one or more of the components using appropriate portions of an appropriate solvent and then mixing up the solutions. If necessary, a dispersion improving agent may be used.

Typically, the SMP polymer compositions are prepared in the absence of air and humidity and are filled in closable containers, such as cartridges, directly after their preparation.

The inventive polymer composition obtained in the above manner can be applied as a one-part curable composition. Such curable composition can be obtained by preparing the polymer composition of the present invention in a substantially moisture free state. When stored in a tightly closed state, such composition can endure long-period storage and, when exposed to atmospheric conditions, it rapidly undergoes curing from the surface.

The curable polymer composition of the present invention is useful as an elastic sealant or adhesive in the fields of building and construction works and in industrial applications. It can also be used as paint, adhesive, poured filler, coating material or the like.

Unless otherwise stated all values given in % are directed to % by weight and all ratio given are based on weight ratio. Unless otherwise stated the term ppm mean mg/kg.

The present invention is further illustrated by the following examples and claims.

### EXAMPLES

Examples and Comparative Examples comprising inventive liquid stabilizer compositions, inventive powder stabilizer composition as well as reference stabilizer compositions were prepared.

### 1. Preparation of Liquid Stabilizer Compositions SC

The following stabilizer compositions were prepared by mixing the components A1,A2, B1 and C1 with the liquid diluent D4. The stabilizer components A1, A2, B1, C1 and D4 are as defined below. Components A1 and A2, respectively, are provided as composition comprising solvents D5.1 (1-methoxy-2-propanol) and D5.2 (xylene) which account to the total amount of liquid diluent D. All amounts given in Table 1 and 2 below refer to the amount of active ingredient in % by weight. The combined amounts of diluents D, as well as the separate amounts of diluents D4, D5.1 and D5.2, are given in % by weight based on the total weight of the respective stabilizer composition.

TABLE 1
Liquid Stabilizer compositions (all amounts given
in % by weight referring to the active ingredient)

| | SC1 | SC2 | SC3 | SC4 |
|---|---|---|---|---|
| A1 | 0.0 | 4.2 | 8.3 | 16.7 |
| A2 | 16.7 | 12.5 | 8.4 | 0.0 |
| B1 | 27.8 | 27.8 | 27.8 | 27.8 |
| C1 | 5.5 | 5.5 | 5.5 | 5.5 |
| D | 50 (D4: 45.8; | 50 (D4: 46.3; | 50 (D4: 46.7; | 50 (D4: 47.5; |
| | D5.1: 0.0; | D5.1: 0.6 | D5.1: 1.2 | D5.1: 2.5 |
| | D5.2: 4.2) | D5.2: 3.1) | D5.2: 2.1) | D5.2: 0.0) |

### Components:

A1: UV absorber composition comprising 85% by weight of a mixture of 2-[4-[(2-hydroxy-3-dodecyloxypropyl)oxy]-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine as active ingredients and 15% by weight of 1-methoxy-2-propanol as liquid diluent D5.1 (Hostavin® 3400 LIQ from Clariant, Frankfurt);
A2: UV absorber composition comprising 80% by weight of 2-ethyl-2′-ethoxy-oxalanilide (CAS-No. 23949-66-8) as active ingredient and 20% by weight of xylene as liquid diluent D5.2 (Hostavin 3206 LIQ from Clariant);
B1: HALS, reaction product of 2,2,4,4-tetramethyl-7-oxa-3,20-diazadispiro-20-(2,3-epoxi-propyl)dispiro-(5.1.11.2)-heneicosane-21-one and epichlorohydrin, (CAS-No. 202483-55-4; Hostavin® N30 from Clariant, Frankfurt);
C1: Phenolic antioxidant, bis-(3,3-bis-(4′-hydoxy-3′-tert.-butylphenyl)butanic acid)-glycolester (CAS-No. 32509-66-3);
D: liquid diluent, in particular D4, D5.1 and D5.2;
D4: liquid diluent, vinyltrimethoxysilane (Dynasylan® VTMO, Evonik);
D5.1: liquid diluent, 1-methoxy-2-propanol;
D5.2: liquid diluent, xylene.

The liquid stabilizer compositions SC1, SC2, SC3 and SC4 were obtained by mixing the components in the amounts given in Table 1 at room temperature. The obtained stabilizer compositions were obtained as transparent, stable, liquid solutions. The stabilizer compositions SC1, SC2, SC3 and SC4 were used in the preparation of the SMP compositions described below.

### Preparation of the SMP Test Samples Using the Liquid Stabilizer Compositions

The following SMP compositions were prepared using SMP1 (Kaneke S303H, silyl-terminated polyether) and one of the liquid stabilizer compositions SC1, SC2, SC3 or SC4, wherein the components SMP1, F1, G1, G2, G3 and G4 were as described below.

| Component | Amount [% by weight] |
|---|---|
| SMP1 | 29.2 |
| SC1/SC2/SC3/SC4 | 1.8 |
| F1 | 52.0 |
| G1 | 14.6 |
| G2 | 0.9 |
| G3 | 0.5 |
| G4 | 1.0 |

The following components were used:

### Component P:

SMP1: Kaneka MS Polymer® S303H, Kaneka, silyl-terminated polyether

### Filler Component F:

F1: Hakuenka® CCR-S10, Omya, precipitated calcium carbonate coated with fatty acids

### Further Components G:

G1: Plasticizer, Mesamoll®, Lanxess, C₁₀-C₂₁ alkane sulfonic acid phenylester,
G2: Adhesion promoter, 3-aminopropyltrimethoxysilan (Dynasylan® AMMO, Evonik);
G3: Catalyst TIB KAT® 223, TIB Chemicals, Dioctyltindiketanoat,
G4: Moisture scavenger, vinyltrimethoxysilane (Dynasylan® VTMO, Evonik);

### Stabilizer Components:

Inventive examples (Ex.1 — Ex.4) are prepared by using the liquid stabilizer compositions SC1, SC2, SC3, and SC4, respectively, according to table 1.

The prepared SMP compositions are summarized in Table 2.

TABLE 2
Overview of formulations, all amounts given in g

| | | Ex. 1 | Ex. 2 | Ex. 3 | Ex. 4 |
|---|---|---|---|---|---|
| | SMP1 | 29.2 | 29.2 | 29.2 | 29.2 |
| | F1 | 52.0 | 52.0 | 52.0 | 52.0 |
| | G1 | 14.6 | 14.6 | 14.6 | 14.6 |
| | G2 | 0.9 | 0.9 | 0.9 | 0.9 |
| | G3 | 0.5 | 0.5 | 0.5 | 0.5 |
| | G4 | 1.0 | 1.0 | 1.0 | 1.0 |
| S | A1 | 0.0 | 0.08 | 0.15 | 0.3 |
| | A2 | 0.3 | 0.22 | 0.15 | 0.0 |
| | B1 | 0.5 | 0.5 | 0.5 | 0.5 |
| | C1 | 0.1 | 0.1 | 0.1 | 0.1 |
| | D | 0.9 | 0.9 | 0.9 | 0.9 |

### Preparation of the SMP Test Samples

In a 150 ml speed mixer cup (PP 250 ml), 52.0 g of filler F1 were added to 29.2 g of polymer SMP1 and 14.6 g of plasticizer G1. The mixture was stirred in a SpeedMixer DAC 600.1 FVZ at 2300 rpm for 30 seconds at ambient temperature. The stabilizer compositions SC1, SC2, SC3 or SC3, in amounts according to table 2, were added to the resulting mixture and stirred for further 60 seconds at 2300 rpm. Finally, 0.9 g of adhesion promoter G2, 1.0 g of moisture scavenger G4 and 0.5 g of catalyst G3 were added to the resulting mixture and stirred for additional 30 seconds at 2300 rpm.

The liquid stabilizer compositions SC1, SC2, SC3 and SC4 can be dosed easily and precisely and do not show any dust formation during the preparation of the SMP test samples.

### Testing of the SMP Test Samples

Heat stability, surface cracking resistance and color were determined for each sample using the testing methods as described below in section 4. The test results are summarized in table 3.

TABLE 3
Results of heat stability, surface cracking resistance (UV stability) and
color measurements for SMP samples using the liquid stabilizer compositions

| | | Heat | | | | | | | |
|---|---|---|---|---|---|---|---|---|---|
| | | Stability | UV | | | | | | |
| | | 110° C. | Stability | YI | YI | dE | dL* | da* | db* |
| No. | Stabilizer | [hours] | [hours] | 0 h | after 2100 h | | | | |
| Ex. 1 | SC1 | 2592 | 2100 | 7.95 | 5.8 | 1.86 | 91.78 | −0.13 | 2.99 |
| Ex. 2 | SC2 | 2376 | 2100 | 7.68 | 5.91 | 1.33 | 92.56 | −0.26 | 3.12 |
| Ex. 3 | SC3 | 2736 | 2500 | 7.59 | 7.28 | 0.84 | 92.2 | −0.33 | 3.85 |
| Ex. 4 | SC4 | 2592 | >2500 | 7.31 | 7.18 | 0.38 | 92.57 | −0.52 | 3.89 |

It is demonstrated that high demands with respect to heat stability and surface cracking resistance are met by SMP test samples using the inventive liquid combination of UV absorber A1 and/or A2, hindered amine light stabilizer B1, phenolic antioxidant C1 and liquid diluent D (cf. Ex.1-Ex.4). Particular high UV stability is achieved for SMP test samples using the inventive stabilizer combination with a ratio of UV absorber A1 to UV absorber A2 higher than 1:1, i.e. when the UV absorber A1 accounts for more than 50% by weight of the total amount of UV absorber (cf. Ex.3 and Ex.4). On the other hand, better heat stability is observed for stabilizer combinations comprising at least one UV absorber A2 (cf. Ex. 3 versus Ex. 4). This also accounts for reduces costs of the stabilizer composition, since oxalanilide UV absorbers such as UV absorber A2 are cheaper compared to (2-hydroxyphenyl)-s-triazine UV absorbers such as UV absorber A1. The initial Yellowness Index (YI at 0 hours) has no significant variation among the samples.

### 2. Preparation and Testing of the SMP Test Samples With Powder Stabilizer Combinations

Several SMP test samples were prepared using powder stabilizer combinations comprising components A, B, and optionally C in the absence of a liquid diluent D. Furthermore, reference examples were made by preparing SMP test samples using conventions stabilizer combinations.

The following components were used:

### Component P:

SMP1: Kaneka® S303H, silyl-terminated polyether

### Stabilizers S:

A3: UV absorber, 2-Ethyl-2′-ethoxy-oxalanilide (CAS-No. 23949-66-8) without liquid diluent;
B1: HALS, reaction product of 2,2,4,4-tetramethyl-7-oxa-3,20-diazadispiro-20-(2,3-epoxi-propyl)dispiro-(5.1.11.2)-heneicosane-21-one and epichlorohydrin, (CAS-No. 202483-55-4; Hostavin® N30 from Clariant, Frankfurt);
C1: Phenolic antioxidant, bis-(3,3-bis-(4′-hydoxy-3′-tert. butylphenyl)butanic acid)-glycolester (CAS-No. 32509-66-3);
R1: Reference 1 is a combination of
   UV-1 UV absorber, 2-(2′-Hydroxy-3′-tert-butyl-5′-methylphenyl)-5-chlorobenzortriazole (CAS-No. 3896-11-5), and
   HALS-1 bis(2,2,6,6-tetramethyl-4-piperidinyl)decandioat (CAS-No. 52829-07-9)
R2: Reference 2 is Tinuvin® 5866 (from BASF), which is a blend of an UV absorber and a basic HALS, wherein the HALS component bis(1,2,2,6,6-pentamethyl-4-piperidyl) [[3,5-bis(1,1-dimethylethyl)-4-hydroxyphenyl]methyl]butylmalonate is included.

### Filler Component F:

F1: Hakuenka® CCR-S10, precipitated calcium carbonate coated with fatty acids

### Further Components G:

G1: Plasticizer, Mesamoll®, C₁₀-C₂₁ alkane sulfonic acid phenylester,
G2: Adhesion promoter, 3-aminopropyltrimethoxysilan (Dynasylan® AMMO, Degussa Evonik);
G3: Catalyst TIB KAT 223, Dioctyltindiketanoat,
G4: Moisture scavenger, vinyltrimethoxysilan (Dynasylan® VTMO, Degussa Evonik);

In a 150 ml speed mixer cup (PP 250 ml), 52.0 g of filler F1 were added to 29.2 g of polymer SMP1 and 14.6 g of plasticizer G1. The mixture was stirred in a SpeedMixer DAC 600.1 FVZ at 2300 rpm for 30 seconds at ambient temperature. Components A3, B1 and C1, in amounts according to tables 4, 5 and 6 below, were added to the resulting mixture and stirred for further 60 seconds at 2300 rpm. Finally, 0.9 g of adhesion promoter G2, 2.0 g of moisture scavenger G4 and 0.5 g of catalyst G3 were added to the resulting mixture and stirred for additional 30 seconds at 2300 rpm. The reference samples Ref.1 to Ref.6 were prepared accordingly using the reference stabilizers R1 and R2.

Heat stability, surface cracking resistance and color were determined for each sample using the testing methods as described in section 4 below.

The following basic formulations as described in table 4 were used:

TABLE 4
Overview of formulations, all amounts given in g

| | | Inventive | Comparative | Comparative |
|---|---|---|---|---|
| | | examples | examples | examples |
| | | Ex. 5-Ex. 19 | Ref. 1-Ref. 4 | Ref. 5-Ref. 6 |
| | SMP1 | 29.2 | 29.2 | 29.2 |
| | F1 | 52.0 | 52.0 | 52.0 |
| | G1 | 14.6 | 14.6 | 14.6 |
| | G2 | 0.9 | 0.9 | 0.9 |
| | G4 | 2.0 | 2.0 | 2.0 |
| | G3 | 0.5 | 0.5 | 0.5 |
| S | A3 | 0.3-0.5 | | |
| | B1 | 0.3-0.5 | | |
| | C1 | 0.0-0.2 | | |
| | UV-1 | | | 0.4 |
| | HALS-1 | | | 0.4 |
| | R2 | | 0.8-1.2 | |

The test results are summarized in the following tables 5 and 6.

It is demonstrated that heat stability and surface cracking resistance of reference materials (Ref.1 to Ref.6) is met or improved using the inventive combination of UV absorber A3, HALS B1 and phenolic antioxidant C1. Ordinary, the inventive stabilizer combination shows 44% greater heat stability and 67% greater surface cracking resistance compared to the reference examples.

Further, the experimental data show that, albeit the inventive combination of UV absorber A3 and hindered amine light stabilizer B1 provides a property combination of heat stability and UV stability to the SMP test samples in the absence of the phenolic antioxidant C1 which is sufficient for numerous applications (heat stability≥1000 h, UV stability≥500 h, Ex. 5, 6, 17, 18), the addition of the phenolic antioxidant C1 results in a significant synergistically improvement of heat stability and surface cracking resistance (Ex.7 to Ex.16, Ex.19).

The initial Yellowness Index (YI at 0 hours) has no significant variation among the samples according to the invention. Average YI of 6.29 is in line with the results of Ref.1 to Ref.4 and lower than results of Ref.5 to Ref.6 (comprising a conventional combination of a hindered amine light stabilizer and a benzotriazole type UV absorber).

TABLE 5
Experimental plan and results (inventive examples)

| | | | | Heat | | | | | | |
|---|---|---|---|---|---|---|---|---|---|---|
| | Stabilizer | | | Stability | UV | | | | | |
| | A3 | B1 | C1 | 110° C. | Stability | YI | dE | dL* | da* | db* |
| No. | [%] | [%] | [%] | [hours] | [hours] | 0 h | after 1000 h | | | |
| Ex. 5 | 0.4 | 0.5 | 0 | 1776 | 1000 | 6.61 | 1.21 | −0.16 | 0.52 | −1.08 |
| Ex. 6 | 0.5 | 0.4 | 0 | 1608 | 1000 | 6.19 | 1.18 | −0.44 | 0.50 | −0.97 |
| Ex. 7 | 0.5 | 0.5 | 0.1 | 2976 | 2500 | 6.14 | 0.59 | −0.45 | 0.26 | 0.26 |
| Ex. 8 | 0.3 | 0.5 | 0.1 | 2184 | 1500 | 5.86 | 0.32 | −0.10 | 0.26 | −0.14 |
| Ex. 9 | 0.3 | 0.3 | 0.1 | 1776 | 1500 | 5.96 | 0.47 | −0.40 | 0.21 | −0.11 |
| Ex. 10 | 0.4 | 0.5 | 0.2 | 2880 | 2500 | 6.76 | 0.38 | −0.25 | 0.28 | −0.05 |
| Ex. 11 | 0.5 | 0.4 | 0.2 | 2784 | 2000 | 6.44 | 0.97 | −0.66 | 0.23 | −0.68 |
| Ex. 12 | 0.5 | 0.3 | 0.1 | 2352 | 2000 | 6.58 | 0.84 | −0.82 | 0.12 | −0.16 |
| Ex. 13 | 0.4 | 0.4 | 0.1 | 2616 | 2000 | 6.11 | 0.21 | −0.10 | 0.16 | −0.13 |
| Ex. 14 | 0.4 | 0.4 | 0.1 | 2616 | 2000 | 6.33 | 0.64 | −0.60 | 0.17 | −0.11 |
| Ex. 15 | 0.3 | 0.4 | 0.2 | 2880 | 2000 | 6.24 | 0.78 | −0.53 | 0.26 | 0.51 |
| Ex. 16 | 0.4 | 0.4 | 0.1 | 2616 | 2000 | 6.30 | 0.77 | −0.70 | 0.29 | −0.99 |
| Ex. 17 | 0.3 | 0.4 | 0 | 1512 | 500 | 6.56 | 1.17 | −0.60 | 0.38 | −0.93 |
| Ex. 18 | 0.4 | 0.3 | 0 | 1440 | 500 | 5.76 | 1.19 | −0.94 | 0.47 | −0.56 |
| Ex. 19 | 0.4 | 0.3 | 0.2 | 2808 | 2500 | 6.57 | 0.83 | −0.27 | 0.20 | 0.75 |

(% is % by weight)

Further, it was surprisingly found that the chemical nature of the phenolic antioxidant is important and that an advantageous synergistic combination is achieved using the phenolic antioxidant C1 in combination with the inventive stabilizer components A and B.

TABLE 6
Experimental plan and results (comparative examples)

| | | | | Heat | | | | | | |
|---|---|---|---|---|---|---|---|---|---|---|
| | Stabilizer | | | Stability | UV | | | | | |
| | UV-1 | HALS-1 | R2 | 110° C. | Stability | YI | dE | dL* | da* | db* |
| No. | [%] | [%] | [%] | [hours] | [hours] | 0 h | after 1000 h | | | |
| Ref. 1 | 0 | 0 | 0.8 | 1776 | 1000 | 6.37 | 1.24 | −0.73 | 0.48 | −0.89 |
| Ref. 2 | 0 | 0 | 1.0 | 1944 | 1500 | 6.29 | 1.29 | −0.16 | 0.56 | −1.16 |
| Ref. 3 | 0 | 0 | 1.0 | 1944 | 1500 | 6.52 | 1.30 | −0.39 | 0.50 | −1.14 |
| Ref. 4 | 0 | 0 | 1.2 | 1944 | 1500 | 5.99 | 1.05 | −0.27 | 0.42 | −0.92 |
| Ref. 5 | 0.4 | 0.4 | 0 | 1776 | 1500 | 8.42 | 1.02 | −0.01 | 0.37 | −0.95 |
| Ref. 6 | 0.4 | 0.4 | 0 | 1800 | 1500 | 8.71 | 1.09 | −0.09 | 0.36 | −1.03 |

(% is % by weight)

The reference examples Ref.1 to Ref.4 demonstrate that conventional state of the art powder stabilizer combinations are often outperformed by the inventive powder stabilizer combinations of UV absorber A3, hindered amine light stabilizer B1 and phenolic antioxidant C1. While the stabilizer combination Ref.1 to Ref.4 are classified as hazardous according to current EU regulations for Classification, Labeling and Packaging of Chemical Substances, the powder stabilizer combinations of Ex.5 to 19 do not require this labeling. Moreover, the reference examples Ref.1 to Ref.4 demonstrate that conventional state of the art powder stabilizer combinations are outperformed by the inventive liquid stabilizer combinations of UV absorbers A1 and/or A2, hindered amine light stabilizer B1, phenolic antioxidant C1 and liquid diluents D (Ex.1 to Ex.4). The liquid stabilizer compositions according to the present invention further have the advantage that is can be easily metered and homogenously incorporated into SMP polymer compositions.

The further reference examples Ref.5 and Ref.6 demonstrate that conventional stabilizer combinations of a hindered amine light stabilizer and a benzotriazole type UV absorber are in particular inferior with respect to initial Yellowness Index (Y1 at 0 hours).

### 3. Preparation and Testing of SMP Test Samples

SMP test samples were prepared based on the components and methods described in section 2. Heat stability, surface cracking resistance and color were determined for each sample using the testing methods as described in section 4. The formulations were based on example Ex.8 in table 5 above and are given as follows (all amounts in g):

| | Examples Ex. 20 to 23 |
|---|---|
| | and Ref. 7 [g] |
| SMP1 | 29.2 |
| F1 | 52.0 |
| G1 | 14.6 |
| G2 | 0.9 |
| G4 | 2.0 |
| G3 | 0.5 |
| A | 0.3 |
| B | 0.5 |
| C | 0.1 |

The components SMP1, F1, G1, G2, G4, and G3 are as described above. The following stabilizers A, B, and C are used:
A3: UV absorber, 2-Ethyl-2′-ethoxy-oxalanilide (CAS-No. 23949-66-8) without liquid diluent;
B1: HALS, reaction product of 2,2,4,4-tetramethyl-7-oxa-3,20-diazadispiro-20-(2,3-epoxi-propyl)dispiro-(5.1.11.2)-heneicosane-21-one and epichlorohydrin (CAS-No. 202483-55-4; Hostavin® N30 from Clariant, Frankfurt);
B2*: Comparative HALS Tinuvin® 622 (BASF SE), poly(4-hydroxy-2,2,6,6-tetramethyl-1-piperidineethanol-alt-1,4-butanedioic acid) (CAS-No. 65447-77-0);
C1: Phenolic antioxidant, bis-(3,3-bis-(4′-hydoxy-3′-tert. butylphenyl)butanic acid)-glycolester (CAS-No. 32509-66-3);
C2: Hostanox® P-EPQ from Clariant, multicomponent system with tetrakis(2,4-di-tert-butylphenyl)-1,1-biphenyl-4,4′-diyIbisphosphonite (CAS-No. 38613-77-3) as main component;
C3: Irganox® 1010, Pentaerythritol tetrakis(3-(3,5-di-tert-butyl-4-hydroxyphenyl)propionate), CAS-No. 6683-19-8;
C4: Tinuvin® 144 (BASF SE), Bis(1,2,2,6,6-pentamethyl-4-piperidinyl)-[[3,5-bis(1,1-dimethylethyl)-4-hydroxyphenyl]methyl]butylmalonate (CAS-No. 63843-89-0).

The SMP formulations and test results are summarized in the following tables 7 and 8.

TABLE 7
SMP Formulations Ex. 20 to Ex. 23 and Ref. 7

| | | | | Amount stabilizer | | |
|---|---|---|---|---|---|---|
| | Stabilizer | | | wt.-% | | |
| No. | A | B | C | A | B | C |
| Ex. 20 | A3 | B1 | C1 | 0.3 | 0.5 | 0.1 |
| Ex. 21 | A3 | B1 | C2 | 0.3 | 0.5 | 0.1 |
| Ex. 22 | A3 | B1 | C3 | 0.3 | 0.5 | 0.1 |
| Ex. 23 | A3 | B1 | C4 | 0.3 | 0.5 | 0.1 |
| Ref. 7 | A3 | B2* | C1 | 0.3 | 0.5 | 0.1 |

TABLE 8
Results Ex. 20 to Ex. 23 and Ref. 7

| | | | | Heat | | | | | | |
|---|---|---|---|---|---|---|---|---|---|---|
| | | | | Stability | UV | | | | | |
| | Stabilizer | | | 110° C. | Stability | YI | dE | dL* | da* | db* |
| No. | A | B | C | [hours] | [hours] | 0 h | after 1000 h | | | |
| Ex. 20 | A3 | B1 | C1 | 2688 | >1600 | 6.86 | 2.00 | −1.96 | 0.34 | −0.26 |
| Ex. 21 | A3 | B1 | C2 | 1608 | 1000 | 7.16 | 3.10 | 2.85 | 0.47 | −1.12 |
| Ex. 22 | A3 | B1 | C3 | 1680 | 1000 | 7.09 | 3.07 | −2.86 | 0.39 | −1.02 |
| Ex. 23 | A3 | B1 | C4 | 2016 | 1500 | 7.37 | 1.63 | −1.03 | 0.50 | −1.15 |
| Ref. 7 | A3 | B2* | C1 | 1940 | 1000 | 6.78 | 2.89 | −2.86 | 0.32 | −0.23 |

The above examples demonstrate that the inventive combination of stabilizer components A and B1, comprising an oligomeric hindered amine light stabilizer according to formulae (II)-1, result in superior heat stability and UV stability compared to conventional oligomeric HALS such as Tinuvin® 622 (cf. Ex.20 and Ref.7).

Moreover, the important impact of the chemical nature of the phenolic antioxidant is substantiated by the examples shown above. It was found that an advantageous synergistic combination is achieved using the phenolic antioxidant C1 in combination with the inventive stabilizer components A and B, in particular B1. The advantageous effect, regarding improved heat stability and improved surface cracking resistance (UV stability) is not achieved using another antioxidant, e.g. comparative stabilizers C2, C3 or C4.

### 4. Testing Methods

### Heat Stability

The heat stability of the SMP samples, prepared as described above, was tested by the following procedure. 25×25×2 mm specimens were cut from the cured film and placed on a cardboard panel, to ensure a homogenous temperature. The panel was placed in the central section of an oven, preheated at a set temperature of either 110° C. (Memmert UF30 ventilated oven). The oven was operated in laboratory environment at controlled temperature of 23±1° C. and controlled humidity of 50±5%. The samples were checked periodically. At 110° C. the maximum interval between observations was 100 hours. A sample was classified as “failed” at the first signs of cracking and removed from the oven. The heat stability is given in hours until failure, as reported in table 3.

### Surface Cracking Resistance

The UV stability (surface cracking resistance) of the SMP samples prepared as described above was determined using weather-o-meter (WoM) according to ISO 4892-2 E2013 wet/dry. The cured samples were exposed to UV radiations with cycles of 102 minutes dry period followed by 18 minutes of water spray with fresh demineralized water. The radiation intensity was 60 W/m² (300-400 nm). The tests were carried out in accordance with ISO 4892-2 E2013 at 50% relative humidity, and a temperature of 65° C.+/−3° C. (black standard).

The samples were checked every 500 hours, till 2000 hours including visual check of surface cracks and color measurement. The samples were checked every 100 hours, starting from 2000 hours including visual check of surface cracks and color measurement. A sample was recorded as “failed” when surface crack was visible. The surface cracking resistance is given in hours until failure. Initial failure at ≥500 h (in particular in combination with other superior properties, e.g. heat stability≥1000 h and good initial Yellowing Index) is considered sufficient for many applications, although initial failure at ≥1000 h is preferred. The surface cracking resistance is given in hours until failure, as reported in table 3.

### Yellowing

The Yellowness Index (YI) of the test samples were measured without UV radiation exposure according to ASTM E313. Furthermore, color measurement based on CIE color system was done before and after 1000 h of thermal exposure at 110° C. in a ventilated oven. CIE LAB values L*, a* and b* as well as dE, were determined using a Spectrophotometer Minolta CM-3600d, calibration with Zero box and white reference plate, wherein L*defines lightness, a* denotes the red/green value and b* the yellow/blue value. The differences of CIE LAB values before and after UV radiation exposure are given in table 3.

### 5. Solubility Evaluation

Solubility of oligomeric light stabilizers Tinuvin® 622 and Hostavin® in different organic solvents and plasticizers was determined according to the following test procedure:

50 ml of the solvent is poured into a 250 ml flask and a magnetic stirrer is put into the flask. Then a small amount of Tinuvin® 622 SF is repeatedly added to the solution with a spatula. When it no longer dissolves, it is heated to 30° C., then small amounts are added again until it no longer dissolves. Repeat with 40° C., 50° C. and 80° C. Depending on the boiling point of the solvent, the temperature is increased by 30° C.

This process is then repeated with Hostavin® N30, but here only room temperature and 50° C. are required.

If the products do not dissolve after one hour, the solubility test is stopped.

The following materials were used:
B1: HALS, reaction product of 2,2,4,4-tetramethyl-7-oxa-3,20-diazadispiro-20-(2,3-epoxi-propyl)dispiro-(5.1.11.2)-heneicosane-21-one and epichlorohydrin (CAS-No. 202483-55-4), (Hostavin® N30 from Clariant);
B2*: Comparative HALS Tinuvin® 622 (BASF SE), poly(4-hydroxy-2,2,6,6-tetramethyl-1-piperidineethanol-alt-1,4-butanedioic acid) (CAS-No. 65447-77-0);
G1: Plasticizer, Mesamoll®, Lanxess, C₁₀-C₂₁ alkane sulfonic acid phenylester,

The solvents ethanol, n-butanol, ethyl acetate and toluene are commercially available.

The plasticizers di-iso-nonylcyclohexane-1,2-dicarboxylate (DINCH; CAS-No. 166412-78-8) and di-iso-nonyl phthalate (DINP; CAS-No. 68515-48-0) are commercially available from various manufacturers.

The results are summarized in the following Tables 9 to 11.

TABLE 9
Solubility results of B1 (Hostavin ® N30) and B2* (Tinuvin ® 622)
in organic solvents, in grams/liter, room temperature (22° C.).

| Oligomeric light | Solvent | | | | | |
|---|---|---|---|---|---|---|
| stabilizer | ethanol | | n-butanol | | ethyl acetate | toluene |
| B1 (Hostavin ® N30) | 340 | g/l | 95 | g/l | 700 g/l | 560 g/l |
| B2* (Tinuvin ® 622) | 1 | g/l | 2 | g/l | 125 g/l | 150 g/l |

In order to obtain an even distribution in the composition, good solubility in a preferably wide range of liquid constituents is required. It was found by the inventors that the hindered amine light stabilizer B according to the present invention meets this requirement for a broad range of organic solvents (cf. Table 9). Moreover, the hindered amine light stabilizer B shows also a good solubility in commonly used SMP sealant plasticizers as demonstrated in Tables 10 and 11.

TABLE 10
Solubility results of B1 (Hostavin ® N30)
and B2* (Tinuvin ® 622) in commonly used
SMP sealant plasticizers, in grams/liter, room temperature (22° C.).

| | Plasticizer | | | |
|---|---|---|---|---|
| | | | di-iso- | di-iso- |
| | | | nonylcyclohexan- | nonyl |
| Oligomeric | G1 | | 1,2-dicarboxylate | phthalate |
| light stabilizer | (Mesamoll ®) | | (DINCH) | (DINP) |
| B1 (Hostavin ® N30) | 47 | g/l | 3 g/l | 3 g/l |
| B2* (Tinuvin ® 622) | 4 | g/l | 3 g/l | 3 g/l |

TABLE 11
Solubility results of B1 (Hostavin ®
N30) and B2* (Tinuvin ® 622) in commonly
used SMP sealant plasticizers, in grams/liter, at 50° C.

| | Plasticizer | | | | | |
|---|---|---|---|---|---|---|
| | | | di-iso- | | di-iso- | |
| | | | nonylcyclohexan- | | nonyl | |
| Oligomeric | G1 | | 1,2-dicarboxylate | | phthalate | |
| light stabilizer | (Mesamoll ®) | | (DINCH) | | (DINP) | |
| B1 (Hostavin ® N30) | 120 | g/l | 115 | g/l | 140 | g/l |
| B2* (Tinuvin ® 622) | 8 | g/l | 10 | g/l | 25 | g/l |

1-20. (canceled)

21. A stabilizer composition comprising:
(A) at least one UV absorber as component A, wherein the UV absorber A comprises:
(A1) one or more (2-hydroxyphenyl)-s-triazine compounds according to formula (I.1) as component A1: 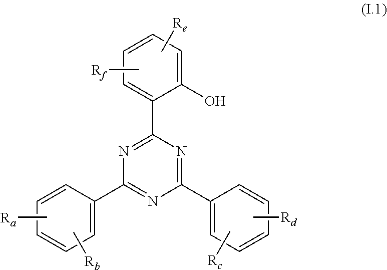
wherein:
Rₐ, R_{b}, R_{c}, R_{d}, Rₑ , and R_{f} are independently of one another selected from hydrogen, alkyl groups having from 1 to 20 carbon atoms, and alkoxy groups having from 1 to 20 carbon atoms and 1 to 4 oxygen atoms;
and/or
(A2) one or more oxalanilide compounds according to formula (I.2) as component A2: 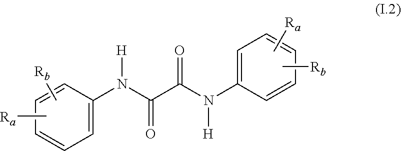
wherein:
Rₐ and R_{b} are independently of one another selected from hydrogen, alkyl groups having from 1 to 20 carbon atoms, and alkoxy groups having from 1 to 20 carbon atoms and 1 to 4 oxygen atoms;
and/or
(B) at least one hindered amine light stabilizer as component B, comprising at least one oligomeric hindered amine light stabilizer B1 according to formula (II)-1: 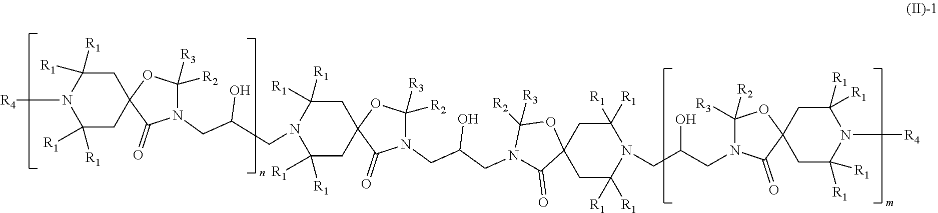
wherein:
n and m are independently of one another an integer from 0 to 100, with the proviso that n and m are not both 0;
R₁ is hydrogen, a cycloalkyl group having from 5 to 7 carbon atoms, or an alkyl group having from 1 to 12 carbon atoms;
R₂ and R₃ are independently of one another selected from hydrogen, an alkyl group having from 1 to 18 carbon atoms, or are, together with the carbon atom connecting them, a 5- to 13-membered cycloalkyl ring, or are, together with the carbon atom connecting them, a group of formula (II)-4: 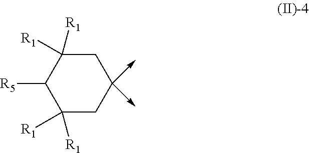
wherein R₁ is as defined above; and
R₄ and R₅ are independently of one another selected from hydrogen, an alkyl group having from 1 to 22 carbon atoms, an oxygen radical O*, —OH, —NO, —CH₂CN, benzyl, allyl, an alkyloxy group having from 1 to 30 carbon atoms, a cycloalkyloxy group having from 5 to 12 carbon atoms, a aryloxy group having from 6 to 10 carbon atoms in which the aryl radical is optionally substituted, a arylalkyloxy group having from 7 to 20 carbon atoms in which the aryl radical is optionally substituted, an alkenyl group having from 3 to 10 carbon atoms, an alkynyl group having from 3 to 6 carbon atoms, an acyl group having from 1 to 10 carbon atoms, halogen, unsubstituted phenyl, and C₁-C₄ -alkyl-substituted phenyl.

22. The stabilizer composition of claim 21, wherein the at least one oligomeric hindered amine light stabilizer component B1 has a (weight average) molecular weight of more than 540 g/mol.

23. The stabilizer composition of claim 21, wherein the stabilizer composition further comprises at least one of the following components C, D, and/or E:
(C) at least one phenolic antioxidant as component C;
(D) at least one liquid diluent as component D; and/or
(E) at least one further additive as component E.

24. The stabilizer composition of claim 23, wherein the at least one phenolic antioxidant component C is composed of one or more phenolic compounds according to the formulae (III)a and/or (III)b: 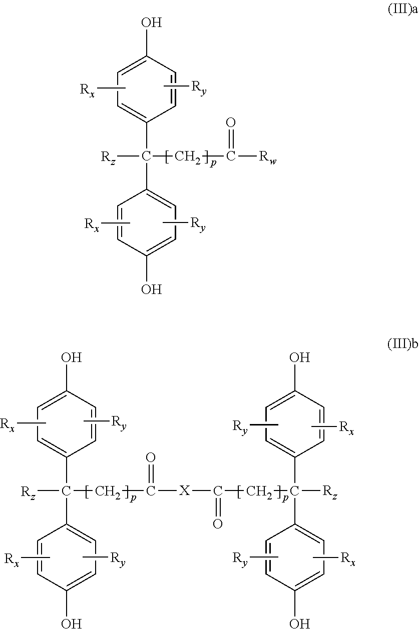
wherein:
Rₓ and R_{y} are independently of one another selected from hydrogen, halogen, and an alkyl group having from 1 to 10 carbon atoms;
R_{z} is hydrogen or an alkyl group having from 1 to 10 carbon atoms;
R_{w} is selected from a hydroxy group, an alkoxy group having from 1 to 18 carbon atoms, a phenyl alkoxy group having from 1 to 4 alkyl carbon atoms, a cycloalkoxy group having from 5 to 8 carbon atoms, and a group of formula (III)c: 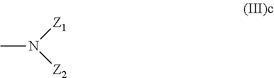
wherein Z 1 and Z2 are independently of one another selected from hydrogen, an alkyl group having from 1 to 18 carbon atoms, a phenyl group, and a cycloalkyl group having from 5 to 8 carbon atoms;
X is selected from —O—(CH₂)_{q}—O—; —(OCH₂—CH₂)_{q}—O—; —O—(CH₂)_{q}—S—(CH₂)_{q}—O; —NH—(CH₂)_{q}—NH—; —NH—NH—,
wherein q is an integer from 1 to 12, and a group 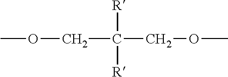
wherein R′ is 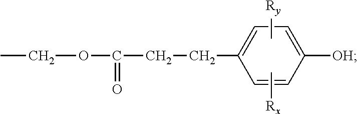
and
p is zero or an integer from 1 to 6.

25. The stabilizer composition of claim 21, wherein the stabilizer composition comprises at least one liquid diluent D selected from liquid adjuvants, liquid solvents, and combinations thereof.

26. The stabilizer composition of claim 21, wherein the stabilizer composition comprises:
(A) 20 to 60% by weight, based on the total stabilizer composition, of the at least one UV absorber A; and
(B) 40 to 80% by weight, based on the total stabilizer composition, of the at least one hindered amine light stabilizer, comprising at least one oligomeric hindered amine light stabilizer B1;
wherein the amounts of components A and B sum up to 100% by weight of the stabilizer composition.

27. The stabilizer composition of claim 21, wherein the stabilizer composition comprises:
(A) 15 to 49% by weight, based on the total stabilizer composition, of the at least one UV absorber A;
(B) 20 to 69% by weight, based on the total stabilizer composition, of the at least one hindered amine light stabilizer B; and
(C) 1 to 50% by weight, based on the total stabilizer composition, of at least one phenolic antioxidant C;
wherein the amounts of components A, B, and C sum up to 100% by weight of the stabilizer composition.

28. The stabilizer composition of claim 21, wherein the stabilizer composition comprises:
(A) 5 to 49% by weight, based on the total stabilizer composition, of the at least one UV absorber A;
(B) 10 to 59% by weight, based on the total stabilizer composition, of the at least one hindered amine light stabilizer B;
(C) 1 to 50% by weight, based on the total stabilizer composition, of at least one phenolic antioxidant C;
(D) 30 to 79% by weight, based on the total stabilizer composition, of at least one liquid diluent D; and
(E) 0 to 50% by weight, based on the total stabilizer composition, of at least one further additive E;
wherein the amounts of components A, B, C, D, and E sum up to 100% by weight of the stabilizer composition.

29. The stabilizer composition of claim 21, wherein the UV absorber A comprises:
(A1) one or more of the (2-hydroxyphenyl)-s-triazine compounds A1 according to formulae (I.1)-1 and (I.1)-2:

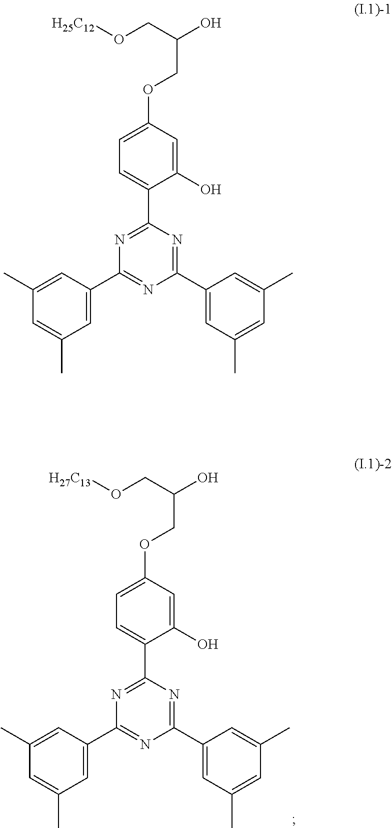

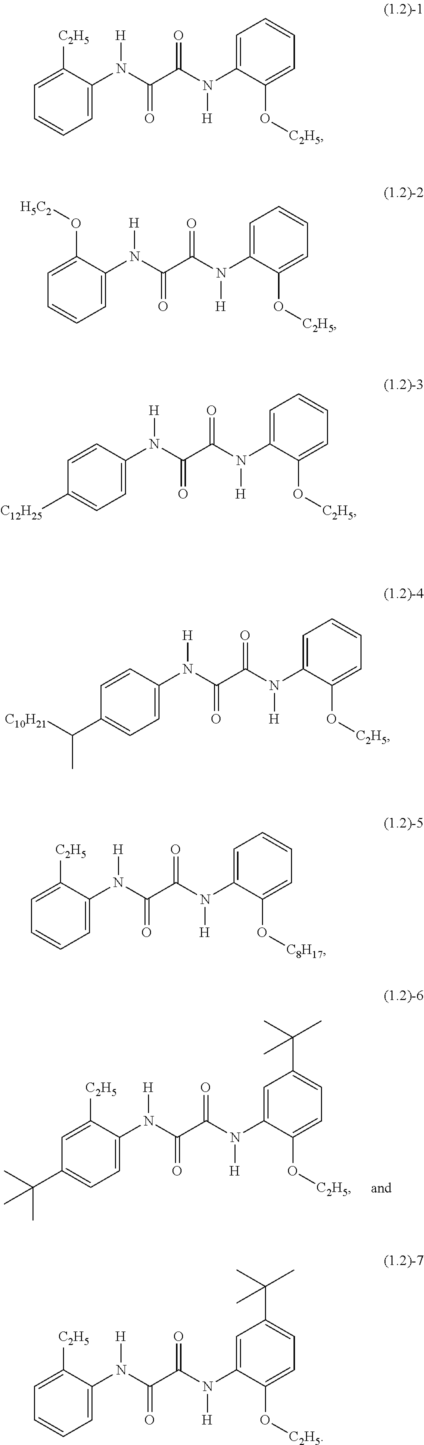

30. The stabilizer composition of claim 21, wherein the hindered amine light stabilizer B is composed of 65 to 95% by weight, based on component B, of at least one compound of formula (II)-1, 5 to 35% by weight, based on component B, of at least one compound of formula (II)-2, and 0 to 10% by weight, based on component B, of at least one compound of formula (II)-3: 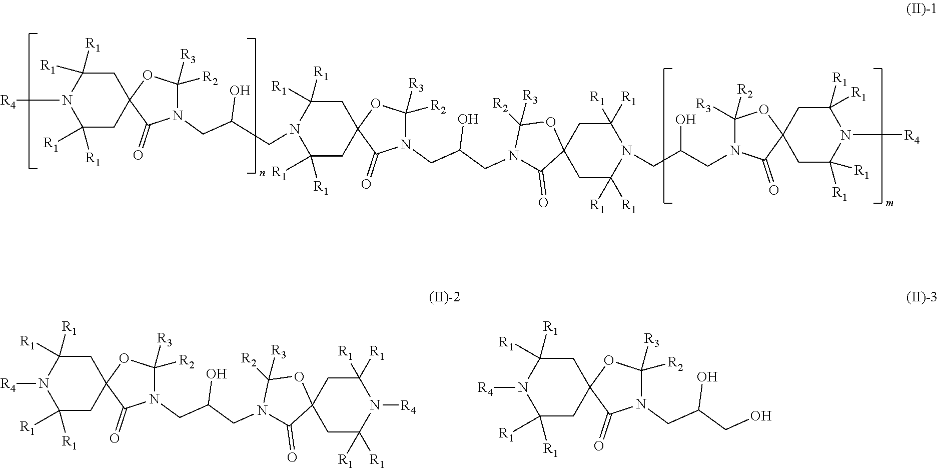
wherein:
n and m are independently of one another an integer from 0 to 100, with the proviso that n and m are not both 0;
R₁ is independently for each of (II)-1, (II)-2, and (II)-3 hydrogen, a cycloalkyl group having from 5 to 7 carbon atoms, or an alkyl group having from 1 to 12 carbon atoms;
R₂ and R₃ are independently of one another, and independently for each of (II)-1, (II)-2, and (II)-3, hydrogen, an alkyl group having from 1 to 18 carbon atoms, or are, together with the carbon atom connecting them, a 5- to 13-membered ring or are, together with the carbon atom connecting them, a group of formula (II)-4: 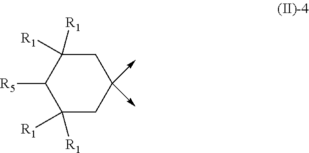
wherein R₁ is as defined above; and
R₄ and R₅ are independently of one another selected from hydrogen, an alkyl group having from 1 to 22 carbon atoms, an oxygen radical O*, —OH, —NO, —CH₂CN, benzyl, allyl, an alkyloxy group having from 1 to 30 carbon atoms, a cycloalkyloxy group having from 5 to 12 carbon atoms, a aryloxy group having from 6 to 10 carbon atoms in which the aryl radical is optionally substituted, an arylalkyloxy group having from 7 to 20 carbon atoms in which the aryl radical is optionally substituted, an alkenyl group having from 3 to 10 carbon atoms, an alkynyl group having from 3 to 6 carbon atoms, an acyl group having from 1 to 10 carbon atoms, halogen, unsubstituted phenyl, and C₁-C₄ -alkyl substituted phenyl.

31. The stabilizer composition of claim 30, wherein the hindered amine light stabilizer B is composed of compounds according to formulae (II)-1 and (II)-2 and optionally (II)-3, wherein:
n and m are independently of one another an integer from 0 to 5, with the proviso that n and m are not both 0;
R₁ is an alkyl group having from 1 to 4 carbon atoms;
R₂ and R₃ are, together with the carbon atom connecting them, a 6- to 12-membered cycloalkyl ring, or are, together with the carbon atom connecting them, a group of formula (II)-4; and
R₄ and R₅ are independently of one another selected from hydrogen, an alkyl group having from 1 to 4 carbon atoms, an alkyloxy group having from 1 to 6 carbon atoms, a cycloalkyloxy group having from 5 to 6 carbon atoms, and an acyl group having from 1 to 4 carbon atoms.

32. The stabilizer composition of claim 23, wherein the antioxidant C comprises a phenolic compound according to formula (III)b, wherein:
Rₓ and R_{y} are independently of one another selected from a branched alkyl group having from 1 to 6 carbon atoms;
R_{z} is selected from hydrogen or an alkyl group having from 1 to 4 carbon atoms;
X is —O—(CH₂)_{q}—O—, wherein q is an integer from 2 to 4; and
p is an integer from 1 to 4.

33. The stabilizer composition of claim 21, comprising:
(A1) the (2-hydroxyphenyl)-s-triazine compounds A1 according to formulae (I.1)-1 and/or (I.1)-2: 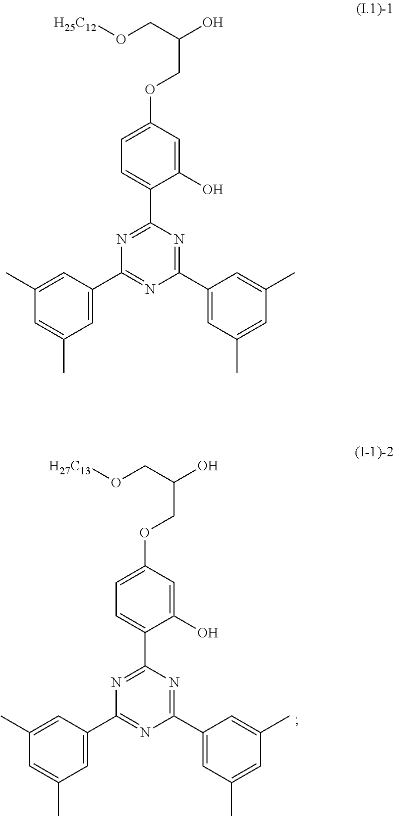
(A2) the oxalanilide compound A2 according to formula (I.2)-1: 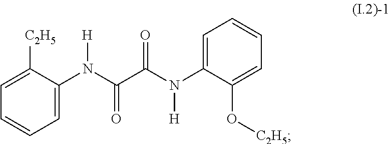 [SMILES: CCOc1ccccc1NC(=O)C(=O)Nc1ccccc1CC]
(B) at least one hindered amine light stabilizer B, comprising at least one oligomeric hindered amine light stabilizer B1; and
(C) at least one antioxidant C comprising the phenolic compound bis-(3,3-bis-(4′-hydoxy-3′-tert-butyl-phenyl)butanoic acid)-glycolester.

34. A process for preparing the stabilizer composition of claim 23, wherein the components A, and B, and optionally C, D, and/or E are mixed.

35. A method of using the stabilizer composition of claim 21 as a stabilizer in sealants or adhesives based on silyl-modified polymers.

36. A polymer composition comprising:
(P) at least one polymer P selected from silyl-modified polymers;
(S) a stabilizer combination S composed of:
at least one UV absorber A;
at least one hindered amine light stabilizer B;
optionally at least one phenolic antioxidant C;
optionally at least one liquid diluent D; and
optionally at least one further additive E;
wherein the components A, B, C, D, and E are as defined in claim 23;
(F) optionally at least one filler F; and
(G) optionally at least one further additive G.

37. The polymer composition of claim 36, wherein the polymer composition comprises:
(P) 5 to 99% by weight, based on the total polymer composition, of the at least one polymer P selected from silyl-modified polymers;
(S) a stabilizer combination S composed of:
0.001 to 3% by weight, based on the total polymer composition, of the at least one UV absorber A;
0.001 to 3% by weight, based on the total polymer composition, of the at least one hindered amine light stabilizer B;
0 to 3% by weight, based on the total polymer composition, of the at least one phenolic antioxidant C;
0 to 3% by weight, based on the total polymer composition, of the at least one liquid diluent D; and
0 to 3% by weight, based on the total polymer composition, of the at least one further additive E;
(F) 0 to 85% by weight, based on the total polymer composition, of at least one filler F; and
(G) 0 to 35% by weight, based on the total polymer composition, of at least one further additive G.

38. The polymer composition of claim 36, wherein the polymer composition comprises:
(P) 7.5 to 95% by weight, based on the total polymer composition, of the at least one polymer P selected from silyl-modified polymers;
(S) a stabilizer combination S composed of:
0.001 to 3% by weight, based on the total polymer composition, of the at least one UV absorber A;
0.001 to 3% by weight, based on the total polymer composition, of the at least one hindered amine light stabilizer B;
0.001 to 3% by weight, based on the total polymer composition, of the at least one phenolic antioxidant C;
0.001 to 3% by weight, based on the total stabilizer composition, of the at least one liquid diluent D; and
0 to 3% by weight, based on the total polymer composition, of the at least one further additive E;
(F) 1 to 80% by weight, based on the total polymer composition, of at least one filler F;
(G1) 1 to 25% by weight, based on the total polymer composition, of at least one plasticizer as further additive G1;
(G2) 1 to 10% by weight, based on the total polymer composition, of at least one adhesion promoter as further additive G2;
(G3) 0.01 to 3% by weight, based on the total polymer composition, of at least one catalyst as further additive G3; and
(G) and 0 to 10% by weight, based on the total polymer composition, of at least one further additive G different from G1 to G3.

39. The polymer composition of claim 36, wherein the silyl-modified polymer P is selected from silyl-modified polyethers according to the following formula (P-II): 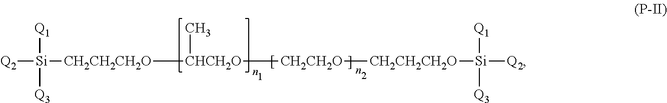
wherein:
Q₁, Q₂, and Q₃ are independently from each other selected from an alkyl group having 1 to 40 carbon atoms, and an alkyoxy group having from 1 to 10 carbon atoms, with the proviso that at least one of Q₁, Q₂, and Q₃ is a cross-linkable hydrolysable silyl group, and n₁ and n₂ are independently from each other an integer from 0 to 1000, with the proviso that n₁+n₂ is at least 50.

40. The polymer composition of claim 36, wherein the stabilizer combination S comprises:
(A) at least one UV absorber A comprising:
(A1) the (2-hydroxyphenyl)-s-triazine compounds (A1) according to formulae (I.1)-1 and/or (I.1)-2: 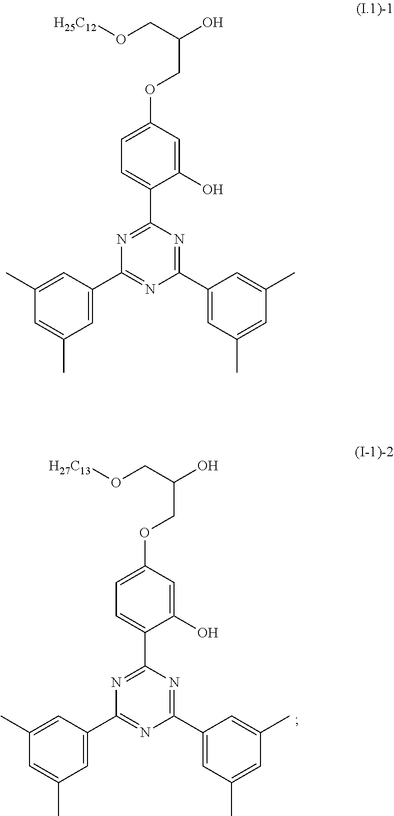
and/or
(A2) the oxalanilide compound A2 according to formula (I.2)-1: 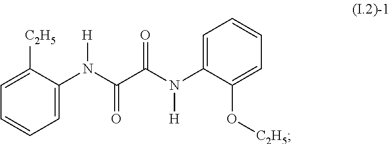 [SMILES: CCOc1ccccc1NC(=O)C(=O)Nc1ccccc1CC]
(B) at least one hindered amine light stabilizer B, comprising at least one oligomeric hindered amine light stabilizer B1; and
(C) at least one phenolic antioxidant C comprising the phenolic compound bis-(3,3-bis-(4′-hydoxy-3′-tert-butyl-phenyl)butanoic acid)-glycolester.
